(19) United States
(12) Patent Application Publication
(10) Pub. No.: US 2010/0144541 A1
(43) Pub. Date: Jun. 10, 2010

(54) DNA-ARRAY-EQUIPPED CARTRIDGE, ANALYZER, AND METHOD FOR USING THE DNA-ARRAY-EQUIPPED CARTRIDGE

(75) Inventors: Masahiro Murasato, Chita-City (JP); Akinobu Oribe, Nagoya-City (JP); Kazunari Yamada, Nagoya-City (JP)

Correspondence Address: CERMAK KENEALY VAIDYA & NAKAJIMA LLP, 515 EAST BRADDOCK RD SUITE B, Alexandria, VA, 22314, US

(73) Assignee: NGK Insulators, Ltd., Nagoya-City (JP)

(21) Appl. No.: 12/621,771

(22) Filed: Nov. 19, 2009

(30) Foreign Application Priority Data
Dec. 9, 2008 (JP) 2008-313336
Sep. 18, 2009 (JP) 2009-218029

(51) Int. Cl. C40B 30/00; C40B 40/08

(52) U.S. Cl. 506/7; 506/17

(57) ABSTRACT

Rotating a cartridge body 54 allows distribution ports and a combined distribution port provided in the cartridge body 54 and a channel inlet 53c provided in an upper surface of a ring array 53 to sequentially face a fluid port 30a of a reaction tank 30 independent of the cartridge body 54. Additionally, rotating the cartridge body 54 allows a plurality of DNA probes 53a to sequentially face a collimating lens 62a serving as a light detector independent of the cartridge body 54.

### BACKGROUND OF THE INVENTION

1. Field of the Invention

The present invention relates to a DNA-array-equipped cartridge, an analyzer, and a method for using the DNA-array-equipped cartridge.

2. Description of the Related Art

Conventionally, a DNA array in which DNA probes are circularly arranged is known. For example, in a DNA array disclosed in Patent Document 1, a plurality of DNA probes are concentrically arranged on a disk-shaped substrate. When the DNA array is rotated once, a DNA array reader detects light incident from each of DNA probes arranged in a circle.

[Patent Document 1] Japanese Unexamined Patent Application Publication No. 2001-238674

### SUMMARY OF THE INVENTION

However, in the technique disclosed in Patent Document 1, before the DNA array reader detects light incident from DNA probes, it is necessary to use a different apparatus to prepare target DNA, carry out a hybridization reaction between the target DNA and the DNA probes, etc. For example, the process from preparation of the target DNA to detection of light incident from the DNA probes subjected to the hybridization reaction involves transporting the DNA array from one apparatus to another.

The present invention has been made in view of the problems described above. A primary object of the present invention is to make it possible to relatively easily carry out the process from preparation of target DNA to detection of light incident from DNA probes at a light detector.

The present invention adopts the following means to achieve the object described above.

A DNA-array-equipped cartridge of the present invention includes a housing rotatable about a center axis;

a plurality of fluid containing spaces formed inside the housing and including a plurality of reagent containing spaces and a DNA array space, the reagent containing spaces holding fluids for preparation of target DNA, the DNA array space formed in a circumferential shape coaxial with the center axis and having a plurality of DNA probes spotted along the circumferential shape; and a plurality of openings communicating with the corresponding fluid containing spaces, formed on an upper side of the housing, and arranged side-by-side along a circumference coaxial with the center axis, wherein rotating the housing allows the plurality of openings to sequentially face a position setting a fluid port of a reaction tank independent of the housing, and allows the plurality of DNA probes to sequentially face a position setting a light detector independent of the housing.

In the DNA-array-equipped cartridge described above, when the housing is rotated to allow the openings of the reagent spaces to sequentially face the fluid port of the reaction tank, the rotation of the housing is temporarily stopped in a state where the opening of each of the reagent spaces faces the reaction tank, so that fluid is transported between the reaction tank and the reagent space. Thus, the target DNA can be prepare and eventually stored in the reaction tank. Next, when the housing is rotated to allow the opening of the DNA array space to face the fluid port of the reaction tank, the target DNA in the reaction tank can flow into the DNA array space and the target DNA can react with each of the DNA probes. Next, when the housing is rotated, light incident from each of the DNA probes subjected to the reaction can be detected by the light detector. Thus, it is possible to relatively easily carry out the process from preparation of the target DNA to detection of light incident form the DNA probes at the light detector.

In the DNA-array-equipped cartridge of the invention, the housing may be formed in a substantially disk-like shape. With this arrangement, the cartridge body is easily rotatable.

In the DNA-array-equipped cartridge of the present invention, the plurality of DNA probes may be spotted along a plurality of circumferential shapes coaxial with the center axis and having different diameters. With this arrangement, it is possible to spot a larger number of DNA probes.

The DNA-array-equipped cartridge of the present invention may further include a circular valve coaxial with the center axis of the housing, unrotatably secured, capable of supporting the reaction tank on an upper side of the circular valve, and having a through hole extending vertically therethrough from the fluid port of the reaction tank, wherein rotating the housing allows the plurality of openings to sequentially face the through hole of the circular valve. With this arrangement, with a relatively simple structure, any one of the fluid containing spaces can communicate with the reaction tank.

In the present invention, the DNA-array-equipped cartridge may further include a light guide configured to the position setting the guide light to the light detector, the light being incident from the DNA probe facing the position setting the light detector. With this arrangement, light incident from each of the DNA probes can be efficiently guided to the position setting the light detector.

In the DNA-array-equipped cartridge including the circular valve of the present invention, the circular valve may include a light guide configured to guide light to the position setting the light detector, the light being incident from the DNA probe facing the position setting the light detector. With this arrangement, the structure becomes simpler than the case where the circular valve and the light guide are formed separately.

In the DNA-array-equipped cartridge including the light guide, the light guide may be a lens configured to collimate and guide light to a position setting the light detector, the light being incident from the DNA probe facing the light detector. With this arrangement, light incident from each of the DNA probes can be more efficiently guided to the position setting the light detector.

In the present invention, the DNA-array-equipped cartridge may further include a highly thermal-conductive member disposed opposite a position setting the light detector with respect to the DNA array space and made of carbon-containing resin or metal. The highly thermal-conductive member made of carbon-containing resin or metal having relatively high thermal conductivity. Therefore, for a hybridization reaction between target DNA and the DNA probe 53a, it is possible to reduce variations in temperature among the spotted DNA probes. Also, an error in light detection due to disturbance can be prevented from occurring. The DNA-array-equipped cartridge including the highly thermal-conductive member may further include a low-reflection ring disposed on the same side as the light detector with respect to the DNA array space, the low-reflection ring having a through portion communicating with the light detector and made of carbon-containing resin or metal. With this arrangement, the error in light detection due to disturbance can be further reliably prevented from occurring.

In the DNA-array-equipped cartridge of the present invention, the plurality of fluid containing spaces may include a column containing space and a waste liquid tank, the column containing space containing a column for purification of the target DNA, the waste liquid tank communicating with an upper part of the column containing space. Also, the plurality of openings may include first and second openings communicating with the column containing space, the first opening communicating with a lower part of the column, the second opening communicating with an upper part of the column. In this case, the second opening is closed, so that the solution containing the target DNA flows through the first opening, passes through the column from the lower side to the upper side, and flows into the waste liquid tank. Hence, the target DNA is absorbed to the column. Then, the first opening is closed, so that the wash liquid flows through the second opening, passes through the upper part of the column, and flows into the waste liquid tank. Thus, the channel from the upper part of the column to the waste liquid tank can be washed. The channel is a space where eluate collects in, which will be described later. Thus, washing the channel can prevent the eluate from being contaminated. Then, the second opening is closed, so that the eluate flows through the first opening but stops at a position in the channel before the eluate reaches the waste liquid tank. Thus, the DNA probes separated from the column is eluted into the eluate. Then, the first opening is closed, so that the eluate is drawn out through the second opening and the eluate is recovered. The eluate can be recovered through the second opening without passing through the column. Thus, recovery loss can be decreased as compared with the arrangement, in which the eluate is recovered through the column.

In the DNA-array-equipped cartridge of the present invention, labeled markers may be spotted at at least two predetermined positions in the DNA array space. With this arrangement, for example, when the DNA array is not horizontal but is inclined, the fluorescence intensities of the labeled markers may vary depending on the inclinations thereof. Hence, correction coefficients can be calculated respectively for the spotted positions of the DNA probes on the basis of the variation amounts of the fluorescence intensities of the labeled markers, and the fluorescence intensities of the DNA probes can be corrected respectively with the correction coefficients.

In the present invention, an analyzer includes a holder for holding the DNA-array-equipped cartridge according to any one of claims 1 to 11; a rotator for rotating, about the center axis, the housing of the DNA-array-equipped cartridge held by the holder; the reaction tank; the light detector; and a liquid transporter for transporting, through the corresponding openings, fluid held in the fluid containing spaces to the reaction tank, and fluid held in the reaction tank to the fluid containing spaces, wherein when the housing of the DNA-array-equipped cartridge held by the holder is rotated by the rotator, the plurality of openings of the DNA-array-equipped cartridge sequentially face the fluid port of the reaction tank, and the plurality of DNA probes sequentially face the light detector.

In the analyzer described above, when the housing is rotated to allow the openings of the reagent spaces to sequentially face the fluid port of the reaction tank, the rotation of the housing is temporarily stopped in a state where the opening of each of the reagent spaces faces the reaction tank, so that fluid is transported between the reaction tank and the reagent space. Thus, the target DNA can be prepare and eventually stored in the reaction tank. Next, when the housing is rotated to allow the opening of the DNA array space to face the fluid port of the reaction tank, the target DNA in the reaction tank can flow into the DNA array space and the target DNA can react with each of the DNA probes. Next, when the housing is rotated, light incident from each of the DNA probes subjected to the reaction can be detected by the light detector. Thus, it is possible to relatively easily carry out the process from preparation of the target DNA to detection of light incident form the DNA probes at the light detector.

A method for using the DNA-array-equipped cartridge in the present invention, the method includes the steps of:

(a) preparing the DNA-array-equipped cartridge in which fluids for preparation of the target DNA are held in the reagent containing spaces;

(b) preparing the reaction tank independent of the housing of the DNA-array-equipped cartridge and holding a sample from which the target DNA is prepared;

(c) rotating the housing to allow the openings of the reagent spaces to sequentially face the fluid port of the reaction tank, temporarily stopping the rotation of the housing in a state where the opening of each of the reagent spaces faces the reaction tank, transporting fluid between the reaction tank and the reagent space to prepare the target DNA, and eventually storing the target DNA in the reaction tank;

(d) rotating the housing to allow the opening of the DNA array space to face the fluid port of the reaction tank, causing the target DNA in the reaction tank to flow into the DNA array space, and causing the target DNA to react with each of the DNA probes; and

(e) rotating the housing and detecting light incident from each of the DNA probes subjected to the reaction by means of the light detector independent of the housing.

With the method for using the DNA-array-equipped cartridge described above, it is possible to relatively easily carry out the process from preparation of the target DNA to detection of light incident from the DNA probes at the light detector.

### BRIEF DESCRIPTION OF THE DRAWINGS

FIG. 1 is a diagram illustrating an overall configuration of an analyzer 90.

FIG. 2 is a perspective assembly diagram of a cartridge 50.

FIG. 3 is a plan view of a ring array 53.

FIG. 4 is a cross-sectional view of the ring array 53, the view being taken along line A-A′ of FIG. 3.

FIG. 5 is a plan view of a first layer 54a of a cartridge body 54.

FIG. 6 is a plan view of a second layer 54b of the cartridge body 54.

FIG. 7 is a plan view of a third layer 54c of the cartridge body 54.

FIG. 8 is a plan view of a fourth layer 54d of the cartridge body 54.

FIG. 9 is an explanatory diagram illustrating a cartridge holding mechanism 80.

FIG. 10 is a partial cross-sectional view of the cartridge 50 attached to the cartridge holding mechanism 80, the view being part of a cross section taken along line B-B′ of FIG. 2.

FIG. 11 is an explanatory diagram illustrating a process of amplifying and preparing genomic DNA of rice.

FIG. 12 is an explanatory diagram illustrating a process of causing the prepared genomic DNA to react with DNA probes.

FIG. 13 is a flowchart illustrating an example of a light detection routine.

FIG. 14 is an explanatory diagram illustrating a way of spotting DNA probes 53a.

FIG. 15 is an explanatory diagram illustrating another way of spotting DNA probes 53a.

FIG. 16 is a perspective assembly diagram of a cartridge 150 having a highly thermal-conductive member 58.

FIG. 17 is a perspective assembly diagram of the cartridge 150 having a low-reflection ring 158.

FIG. 18 is an explanatory diagram illustrating the periphery of a column containing space 306.

FIG. 19 is an explanatory diagram illustrating the periphery of another column containing space 306.

FIG. 20 is an explanatory diagram illustrating a zigzag diffusion channel 327f.

FIG. 21 is an explanatory diagram illustrating a state in which the cartridge 50 is attached to the rotating stage 38.

FIG. 22 is an explanatory diagram illustrating a ring array 53 having labeled markers 53m.

FIG. 23 is an explanatory diagram illustrating the detail of a reaction tank 30, FIG. 23(a) illustrating a state in which a short rotor 74 is provided, FIG. 23(b) illustrating a state in which a long rotor 75 is provided.

FIG. 24 is a perspective view of a channel from a connection port 328h to a waste liquid tank 328.

### DESCRIPTION OF THE PREFERRED EMBODIMENTS

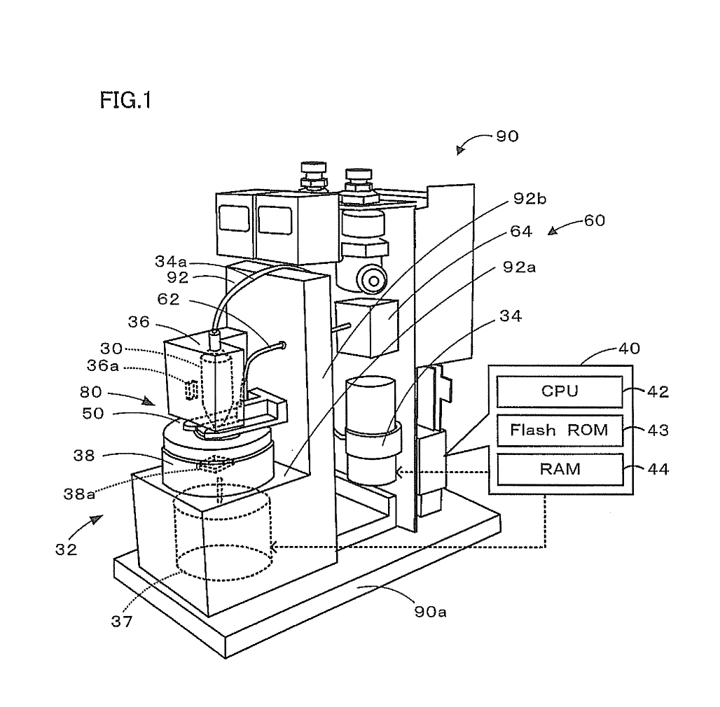

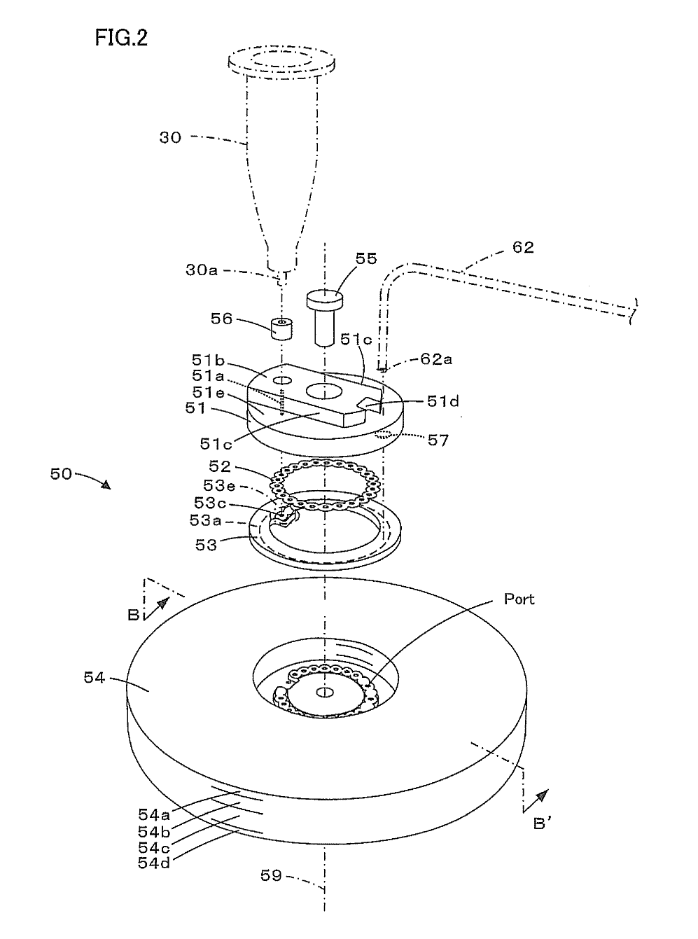

The best mode for carrying out the present invention will now be described with reference to the drawings. FIG. 1 is a diagram illustrating an overall configuration of an analyzer 90. FIG. 2 is a perspective assembly diagram of a cartridge 50. In the present embodiment, the analyzer 90 will be described as an apparatus for identifying the species of rice from DNA.

As illustrated in FIG. 1, the analyzer 90 includes a cartridge holding mechanism 80 to which the cartridge 50 can be attached, a reaction tank 30 in which liquid can be held, and a rotating mechanism 32 that rotates the cartridge 50 about a center axis of the cartridge 50. The analyzer 90 further includes a pump 34 that applies a differential pressure to a liquid container of the cartridge 50 and to the reaction tank 30 to transport liquid, a reaction-tank securing unit 36 that secures the reaction tank 30 to a supporting member 92, and a light detecting unit 60 that inputs light through an optical fiber 62 and detects the light. The analyzer 90 further includes a start button (not shown) the user uses to give an instruction to start processing in the analyzer 90, and a controller 40 that controls an overall operation of the analyzer 90. The analyzer 90 further includes a Peltier device 38a that can regulate the temperature of the cartridge 50 held by the cartridge holding mechanism 80, and a Peltier device 36a that can regulate the temperature of the reaction tank 30. The analyzer 90 has a rectangular base 90a at the bottom, and the supporting member 92 disposed on the front side of the base 90a. The supporting member 92 is L-shaped in side view. The supporting member 92 has a middle surface 92a and an upright wall portion 92b standing upward on the back side of the middle surface 92a. The pump 34 and the controller 40 are provided behind the supporting member 92.

As illustrated in FIG. 2, the cartridge 50 includes a circular valve 51 into which the reaction tank 30 is inserted, a ring array 53 in which a plurality of DNA probes 53a are spotted along a circumference of the ring array 53, and a cartridge body 54 to which the circular valve 51 and the ring array 53 are attached with a center pin 55. A plurality of ports are arranged side-by-side in an upper side of the cartridge body 54.

The circular valve 51 is a circular member coaxial with a center axis 59 of the cartridge body 54. The circular valve 51 is provided with a condenser lens 57. The circular valve 51 is supported by the center pin 55 inserted through the center thereof. The circular valve 51 includes a block 51b at the top. The block 51b has upright walls 51c and 51c parallel to each other and a notch 51d. A retainer 84 (see FIG. 9) sandwiches the upright walls 51c and 51c of the block 51b to unrotatably secure the circular valve 51. The circular valve 51 is connected to the reaction tank 30 through a tubular plastic packing 56, and has a through hole 51a vertically extending therethrough from a fluid port 30a at the lower end of the reaction tank 30. For better water repellency and oil repellency, fluorine-based material, such as Teflon (registered trademark), is used to form the circular valve 51. The material of the circular valve 51 and the mounting position of the condenser lens 57 are designed such that light incident from one of the plurality of DNA probes 53a is collimated by the condenser lens 57 and is incident on a collimating lens 62a attached to an end of the optical fiber 62. Note that the condenser lens 57 is bonded to the circular valve 51 by an adhesive after being separately produced.

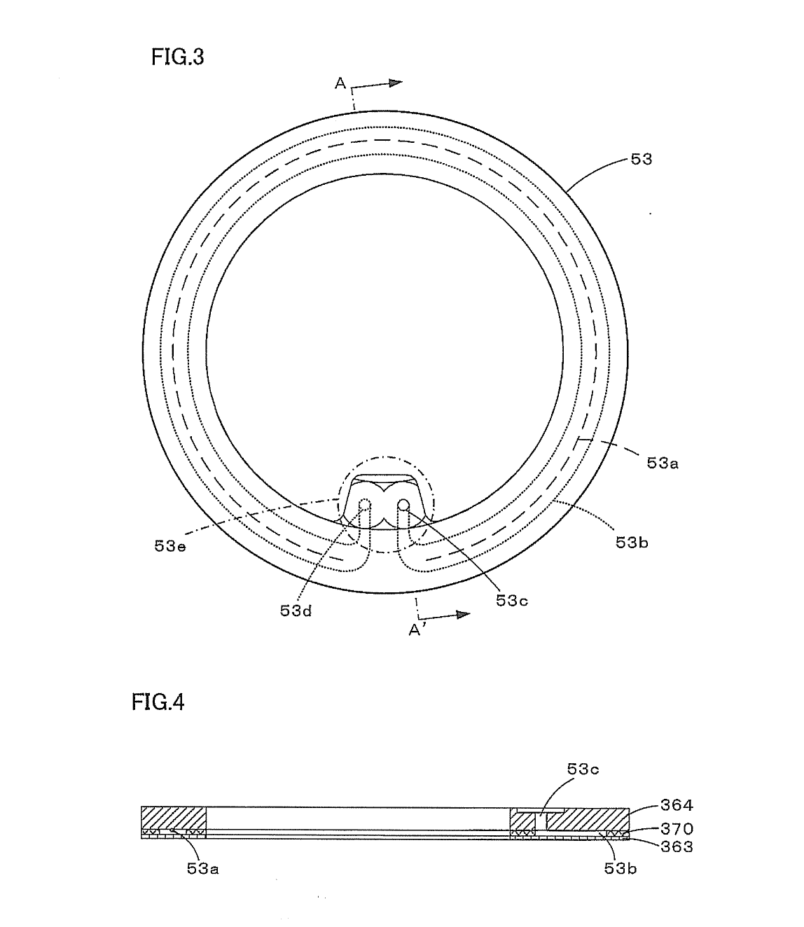

In the ring array 53, the plurality of DNA probes 53a are spotted along the circumference coaxial with the center axis 59 of the cartridge body 54. FIG. 3 is a plan view of the ring array 53. FIG. 4 is a cross-sectional view of the ring array 53, the view being taken along line A-A′ of FIG. 3. As illustrated in FIG. 3 and FIG. 4, the ring array 53 has a reaction channel 53b in which the DNA probes 53a are arranged in a row. The ring array 53 has a protrusion 53e protruding radially. A channel inlet 53c and a channel outlet 53d are formed on the upper side of the protrusion 53e.

As illustrated in FIG. 4, a lower member 363 and an upper member 364 are bonded together by an adhesive sheet 370 (e.g., 531N#80 produced by Nitto Denko Corporation, or titer stick produced by Kajixx Co., Ltd.) to form the ring array 53. The lower member 363 is a 0.1-mm-thick plate-like member made of polycarbonate. The upper member 364 is a 1.0-mm-thick plate-like member also made of polycarbonate. The adhesive sheet 370 has a through hole having a shape corresponding to the shape of the reaction channel 53b circumferentially formed. Thus, the reaction channel 53b is defined by bonding the upper member 364 and the lower member 363, with the adhesive sheet 370 interposed therebetween. When the ring array 53 is mounted on the cartridge body 54, the lower member 363 smaller in thickness than the upper member 364 is disposed on the lower side (adjacent to a rotating stage 38). Therefore, as compared to the case where the upper member 364 is disposed on the lower side, the temperature of liquid inside the reaction channel 53b can be regulated more easily by the Peltier device 38a (see FIG. 1) inside the rotating stage 38. The DNA probes 53a are spotted on the lower surface of the upper member 364, the lower surface being adjacent to the reaction channel 53b. As illustrated in FIG. 3 and FIG. 4, the width and height of the reaction channel 53b are circumferentially constant.

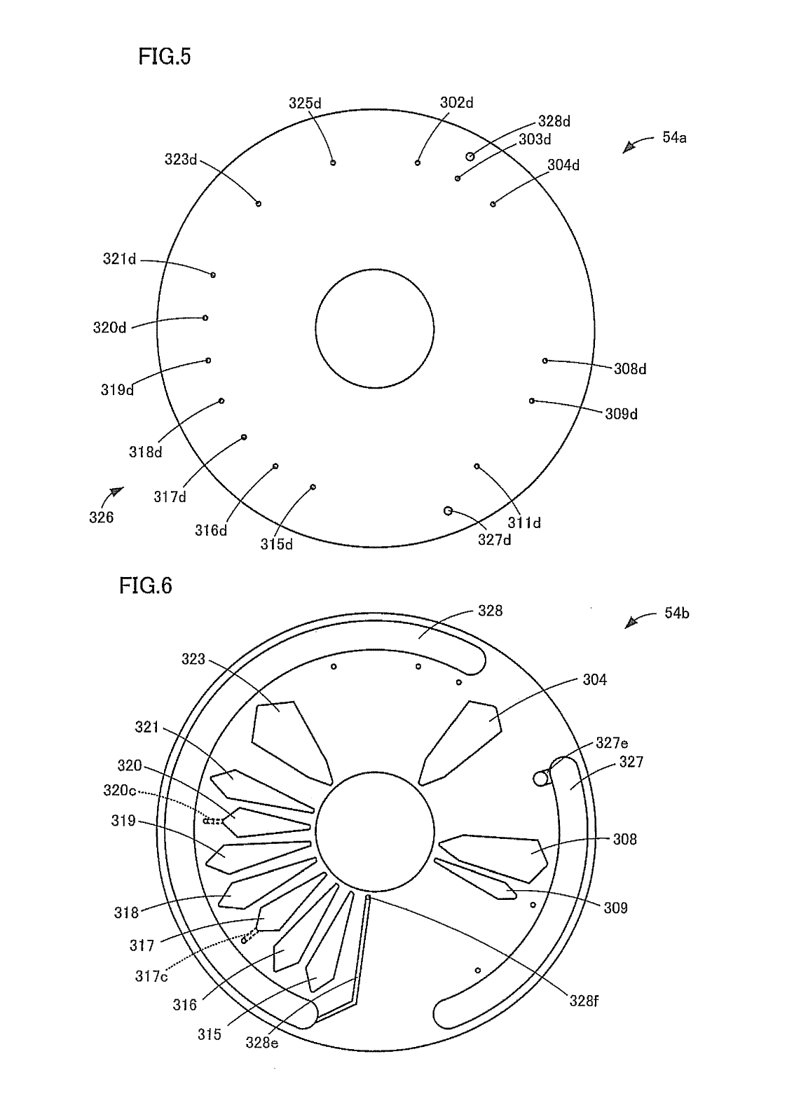

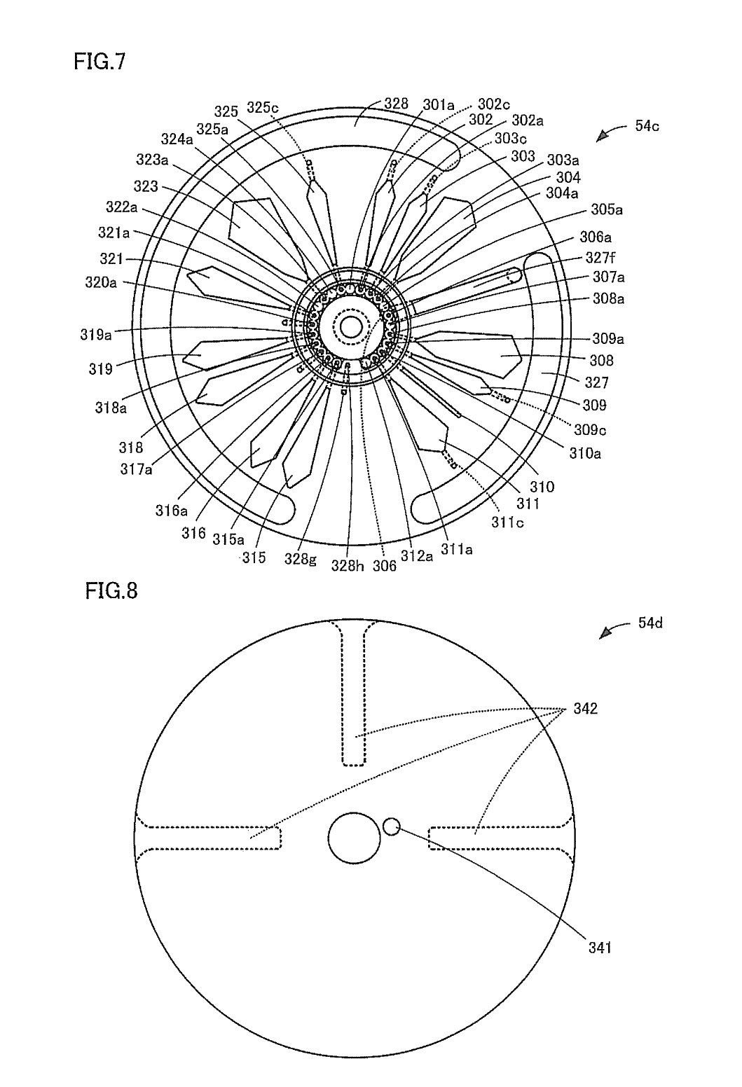

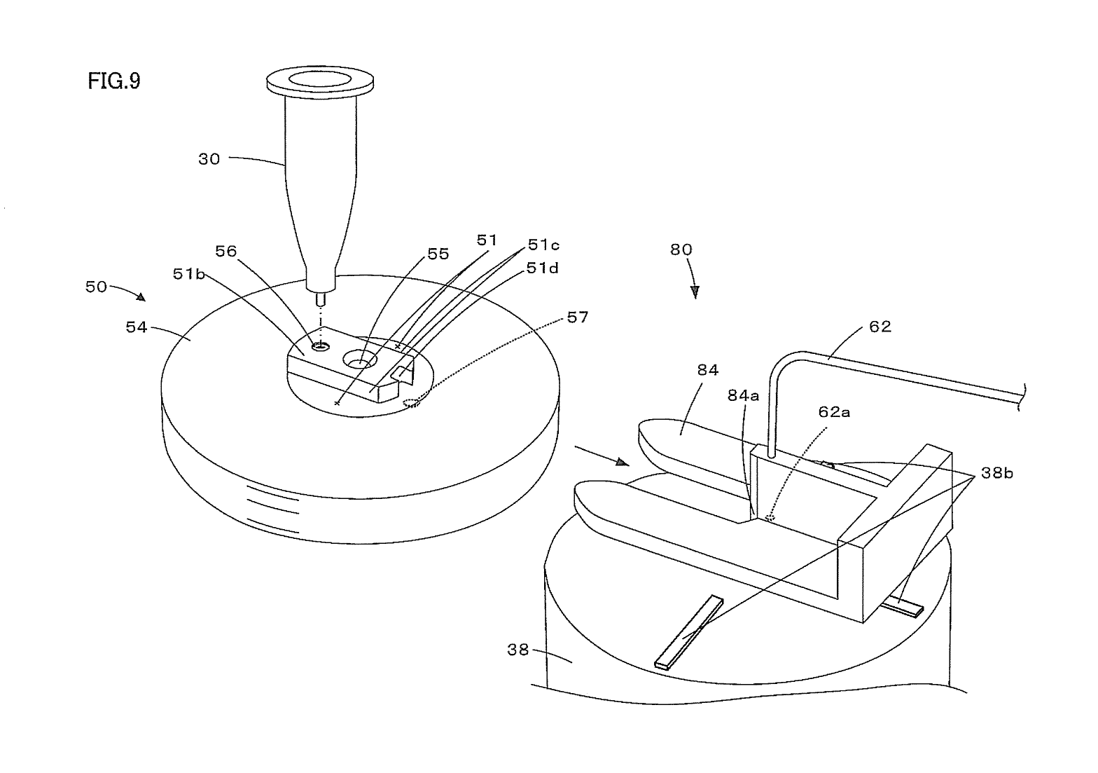

The cartridge body 54 is a disk-like member made of cyclo-olefin copolymer, and is composed of four disk-like layers: a first layer 54a, a second layer 54b, a third layer 54c, and a fourth layer 54d. FIG. 5 is a plan view of the first layer 54a of the cartridge body 54, FIG. 6 is a plan view of the second layer 54b of the cartridge body 54, FIG. 7 is a plan view of the third layer 54c of the cartridge body 54, and FIG. 8 is a plan view of the fourth layer 54d of the cartridge body 54. As illustrated in FIG. 2, the cartridge body 54 has a recess at the center of the upper side thereof. The ring array 53, a linked packing member 52, and the circular valve 51 are fitted into the recess in this order. As illustrated in FIG. 8, the fourth layer 54d has, in its lower surface, three grooves 342 extending radially, and a filling opening 341 for filling a column. As illustrated in FIG. 5 to FIG. 8, the cartridge body 54 has a plurality of liquid containers 302 to 304, 308, 309, 311, 315 to 321, 323, and 325 capable of holding liquids and a plurality of distribution ports 302a to 304a, 308a, 309a, 311a, 315a to 321a, 323a, and 325a. When the cartridge body 54 is rotated, one of the distribution ports 302a to 304a, 308a, 309a, 311a, 315a to 321a, 323a, and 325a allows the corresponding liquid container to communicate with the reaction tank 30 at a predetermined position. The cartridge body 54 also has outside-air distribution portions 326 that allow the liquid containers 302 to 304, 308, 309, 311, 315 to 321, 323, and 325 to communicate with the outside air, so that the outside air can be taken in the liquid containers 302 to 304, 308, 309, 311, 315 to 321, 323, and 325, and gas can be exhausted from the liquid containers 302 to 304, 308, 309, 311, 315 to 321, 323, and 325. The cartridge body 54 also has waste liquid tanks 327 and 328 capable of holding waste liquids supplied from the reaction tank 30, a column containing space 306 containing a column capable of adsorbing a product of a reaction in the reaction tank 30, and a combined distribution port 306a. When the cartridge body 54 is rotated, the combined distribution port 306a allows one of the waste liquid tanks 327 and 328 to communicate with the reaction tank 30 at a predetermined position. The cartridge body 54 also has closed ports 301a, 305a, 307a, 312a, 322a, and 324a, each having no hole. The cartridge body 54 also has a closed channel 310 that does not communicate with the outside air and is capable of holding liquid, and an injection port 310a used to inject liquid into the closed channel 310 and supply liquid held in the closed channel 310 to the reaction tank 30. When the ring array 53 is mounted on the cartridge body 54, the above-described ports of the cartridge body 54 and the channel inlet 53c of the ring array 53 are arranged along the circumference coaxial with the center axis 59. Hereinafter, the liquid containers 302 to 304, 308, 309, 311, 315 to 321, 323, and 325 and the waste liquid tanks 327 and 328 may be collectively referred to as “chambers”.

The liquid containers 302 to 304, 308, 309, 311, 315 to 321, 323, and 325 each are a space narrowed at both ends. Of these liquid containers, the liquid containers 304, 308, 309, 315, 316, 318, 319, 321, and 323 each are configured to hold a large amount of liquid and are formed as a space extending from the second layer 54b to the third layer 54c, while the liquid containers 302, 303, 311, 317, 320, and 325 each are configured to hold a small amount of liquid and are formed only in one of the second layer 54b and the third layer 54c. The liquid containers 302 to 304, 308, 309, 311, 315, 316, 318, 319, 321, 323, and 325 are connected, at their respective one ends adjacent to the center of the cartridge body 54, to the distribution ports 302a to 304a, 308a, 309a, 311a, 315a, 316a, 318a, 319a, 321a, 323a, and 325a, respectively, through channels formed in the lower surface of the third layer 54c and connected to the corresponding liquid containers, and further through vertical channels in the third layer 54c and the second layer 54b. The liquid containers 317 and 320 are connected, at their respective one ends adjacent to the center of the cartridge body 54, to the distribution ports 317a and 320a, respectively, through vertical channels formed in the third layer 54c and further through radial channels connected to the vertical channels. The liquid containers 302 to 304, 308, 309, 311, 315 to 321, 323, and 325 are connected, at their respective other ends remote from the center of the cartridge 50, to the outside-air distribution portions 326. A detailed description of the outside-air distribution portions 326 will be given later.

The distribution ports 302a to 304a, 308a, 309a, 311a, 315a to 321a, 323a, and 325a are openings communicating with the liquid containers 302 to 304, 308, 309, 311, 315 to 321, 323, and 325, respectively. The distribution ports 302a to 304a, 308a, 309a, 311a, 315a to 321a, 323a, and 325a are used to supply liquids from the corresponding liquid containers 302 to 304, 308, 309, 311, 315 to 321, 323, and 325, and formed in the upper surface of the third layer 54c. The distribution ports 302a to 304a, 308a, 309a, 311a, 315a to 321a, 323a, and 325a are arranged along a circumference coaxial with a rotation axis about which the cartridge body 54 is rotated by the rotating mechanism 32. That is, the distribution ports 302a to 304a, 308a, 309a, 311a, 315a to 321a, 323a, and 325a are arranged along a circumference coaxial with the center axis 59 of the cartridge body 54. By a differential pressure applied to liquid held in one of the liquid containers 302 to 304, 308, 309, 311, 315 to 321, 323, and 325 connected to the distribution ports 302a to 304a, 308a, 309a, 311a, 315a to 321a, 323a, and 325a, respectively, the liquid held in the liquid container can be supplied to the reaction tank 30.

The outside-air distribution portion 326 is a general term used to refer to any of outside-air distribution channels 302c, 303c, 309c, 311c, and 325c formed in the lower surface of the third layer 54c and radially extending outward from the respective one ends of the liquid containers 302, 303, 309, 311, and 325 remote from the center of the cartridge body 54; outside-air distribution channels 317c and 320c formed in the lower surface of the second layer 54b and radially extending outward from the respective one ends of the liquid containers 317 and 320 remote from the center of the cartridge body 54; and air vents 302d to 304d, 308d, 309d, 311d, 315d to 321d, 323d, and 325d vertically formed in the first layer 54a. Of the air vents 302d to 304d, 308d, 309d, 311d, 315d to 321d, 323d, and 325d, the air vents 302d, 303d, 309d, 311d, and 325d allow the corresponding liquid containers 302, 303, 309, 311, and 325 to communicate with the outside air, through the corresponding outside-air distribution channels 302c, 303c, 309c, 311c, and 325c and further through the corresponding channels vertically formed in the second layer 54b and the third layer 54c. The air vents 317d and 320d allow the corresponding liquid containers 317 and 320 to communicate with the outside air, through the corresponding outside-air distribution channels 317c and 320c and further through the corresponding channels vertically formed in the second layer 54b. The air vents 304d, 308d, 315d, 316d, 318d, 319d, 321d, and 323d allow the corresponding liquid containers 304, 308, 315, 316, 318, 319, 321, and 323 to directly communicate with the outside air.

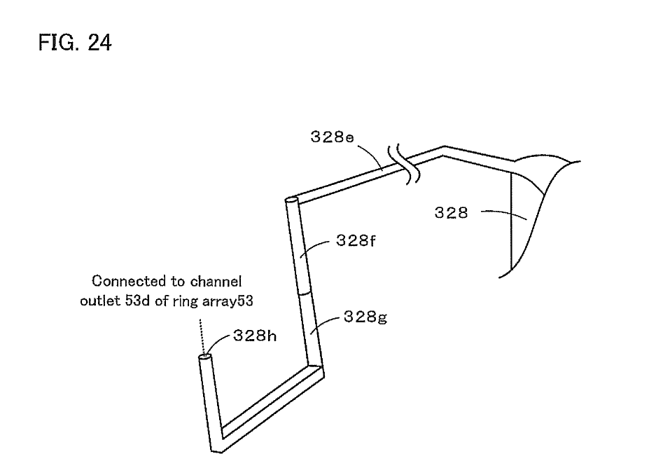

As illustrated in FIG. 6 and FIG. 7, the waste liquid tanks 327 and 328 each are a space provided along the outermost circumference of the cartridge body 54 and formed as a single space extending from the second layer 54b to the third layer 54c. The waste liquid tank 327 is connected to the column containing space 306 through a radially extending waste liquid channel 327e connected to the waste liquid tank 327 and formed in the second layer 54b, a channel vertically extending through the second layer 54b from one end of the waste liquid channel 327e adjacent to the center of the cartridge body 54, and a diffusion channel 327f connected to this channel and extending radially. That is, fluid that has passed from the combined distribution port 306a through the column containing space 306 is discharged to the waste liquid tank 327. On the other hand, the waste liquid tank 328 is connected, through a waste liquid channel 328e connected to the waste liquid tank 328, to a vertical channel 328f provided in the second layer 54b. The channel 328f is connected to a vertical channel 328g provided in the third layer 54c. The channel 328g is connected to a connection port 328h, through a radial channel and a vertical channel that are provided in the third layer 54c. That is, when the ring array 53 is mounted on the cartridge body 54, the channel outlet 53d (see FIG. 3) of the ring array 53 is connected to the connection port 328h. Then, liquid that has passed through the reaction channel 53b of the ring array 53 is eventually discharged to the waste liquid tank 328. FIG. 24 three-dimensionally illustrates the channel from the connection port 328h to the waste liquid tank 328. The first layer 54a has air vents 327d and 328d that allow their corresponding waste liquid tanks 327 and 328 to communicate with the outside air.

The column containing space 306 is provided between the combined distribution port 306a and the diffusion channel 327f, and includes a column. A ceramic column (e.g., silica gel column) is used here. When the pump 34 is actuated to increase pressure in the reaction tank 30, liquid held in the reaction tank 30 is distributed to the column containing space 306 and allowed to collect in the diffusion channel 327f. If further pressure is applied, the liquid collecting in the diffusion channel 327f is stored in the waste liquid tank 327. If the applied pressure is reduced, the liquid passes through the column containing space 306 again and is stored in the reaction tank 30. Filling the column of the column containing space 306 is effected by covering the lower surface of the fourth layer 54d after filling the column from the lower surface of the fourth layer 54d through the filling opening 341. Thus, replacement of the column in the column containing space 306 is effected by uncovering the lower surface of the fourth layer 54d, if necessary.

The combined distribution port 306a and the channel inlet 53c of the ring array 53 are openings that communicate with the waste liquid tanks 327 and 328, respectively, and through which liquids are eventually stored in the waste liquid tanks 327 and 328. The combined distribution port 306a is provided in the upper surface of the third layer 54c, and the channel inlet 53c is provided in the upper surface of the ring array 53 (see FIG. 3). The combined distribution port 306a and the channel inlet 53c are arranged side-by-side along the circumference coaxial with the rotation axis about which the cartridge body 54 is rotated by the rotating mechanism 32 (see FIG. 1). That is, the combined distribution port 306a and the channel inlet 53c are arranged side-by-side along the circumference coaxial with the center axis 59 of the cartridge body 54.

The closed ports 301a, 305a, 307a, 312a, 322a, and 324a are non-hole portions of the third layer 54c, and their positions are defined by the linked packing member 52 (see FIG. 2). The linked packing member 52 is an integrally-molded member having a plurality of O-rings arranged in a row along the circumference.

The closed channel 310 is formed as a groove in the third layer 54c. The closed channel 310 is connected to the injection port 310a through a radially extending channel formed in the third layer 54c and a vertical channel connected to this radially extending channel. Unlike in the case of the liquid containers described above, one end of the closed channel 310 remote from the center of the cartridge body 54 is not connected to any of the outside-air distribution portions 326. Therefore, when the closed channel 310 does not communicate with the reaction tank 30, the injection port 310a is closed by the lower surface of the circular valve 51, so that the closed channel 310 becomes a closed space.

The injection port 310a is an opening communicating with the closed channel 310 and provided in the upper surface of the third layer 54c. The injection port 310a is used to store liquid in the closed channel 310 or supply liquid held in the closed channel 310 to the reaction tank 30. The injection port 310a and the other ports are arranged along the circumference coaxial with the rotation axis about which the cartridge body 54 is rotated by the rotating mechanism 32 (see FIG. 1). That is, injection port 310a and the other ports are arranged along the circumference coaxial with the center axis 59 of the cartridge body 54.

The cartridge holding mechanism 80 is a mechanism to which the cartridge 50 is attached. FIG. 9 is an explanatory diagram illustrating the cartridge holding mechanism 80. As illustrated in FIG. 1 and FIG. 9, the cartridge holding mechanism 80 includes the retainer 84 that biases the cartridge 50 downward, and the rotating stage 38 on which the cartridge 50 is placed. To provide higher thermal resistance, better thermal insulation, easier sliding of the cartridge 50, etc., fluorine-based material, such as Teflon, is used to form the retainer 84. To unrotatably secure the circular valve 51 of the cartridge 50 placed on the rotating stage 38, the retainer 84 presses the circular valve 51 downward while sandwiching the upright walls 51c and 51c of the block 51b. Therefore, even when the cartridge body 54 is rotated by the rotating stage 38, the vertical movement and rotational direction movement of the circular valve 51 are limited, so that the through hole 51a is held at the same position. Thus, rotating the cartridge body 54 allows only one of the ports to communicate with the reaction tank 30. The retainer 84 has a contact portion 84a, as illustrated in FIG. 9. When the cartridge 50 is attached to the cartridge holding mechanism 80, the contact portion 84a is fitted into contact with the notch 51d of the circular valve 51.

As illustrated in FIG. 1, the rotating mechanism 32 includes the rotating stage 38 on which the cartridge 50 is placed, and a motor 37 that rotates the rotating stage 38 in a stepwise manner such that the rotating stage 38 is secured at a predetermined position. The rotating stage 38 is a disk-like member rotatably supported by a shaft on the middle surface 92a of the supporting member 92. The rotating stage 38 is formed by applying electroless nickel plating to a copper member. The rotating stage 38 has three raised portions 38b (see FIG. 9) formed on its upper surface. The bottom surface of the cartridge body 54 has the three grooves 342 (see FIG. 8) at positions corresponding to the raised portions 38b. The cartridge 50 and the rotating stage 38 are combined by fitting the raised portions 38b into the corresponding grooves 342. The Peltier device 38a for the cartridge 50 is provided inside the rotating stage 38. By regulating the temperature of the rotating stage 38, the Peltier device 38a can regulate the temperature of the cartridge 50 on the rotating stage 38 at a constant level. The material used to form the rotating stage 38 may be an anodized aluminum. The motor 37 mentioned above is a stepping motor.

The reaction-tank securing unit 36 is formed by applying electroless nickel plating to a copper member. The reaction-tank securing unit 36 is secured to the center of the upright wall portion 92b of the supporting member 92. At a position above the cartridge 50 placed on the rotating stage 38, the reaction-tank securing unit 36 removably secures the reaction tank 30. The Peltier device 36a for the reaction tank 30 is provided inside the reaction-tank securing unit 36. By regulating the temperature of the reaction-tank securing unit 36, the Peltier device 36a can regulate the temperature of the reaction tank 30 at a constant level. The material used to form the reaction-tank securing unit 36 may be an anodized aluminum.

The reaction tank 30 is made of polypropylene. As illustrated in FIG. 1 and FIG. 2, the reaction tank 30 is a tubular member tapered downward toward the corresponding port. The reaction tank 30 is attached at its lower end through the packing 56 to the circular valve 51 (see FIG. 2), and connected at its upper end to an air supply/exhaust tube 34a (see FIG. 1). Pressure generated by actuation of the pump 34 is applied through the air supply/exhaust tube 34a to the reaction tank 30. The pressure is further applied to any of the chambers of the cartridge body 54 connected to the reaction tank 30 through the circular valve 51. In the reaction tank 30, liquids absorbed from the liquid containers 302 to 304, 308, 309, 311, 315 to 321, 323, and 325 are held, stirred, and subjected to various reactions.

The pump 34 is a so-called tube pump that applies pressure, by squeezing its tube with rollers, to a component connected to the tube. As illustrated in FIG. 1, the pump 34 is connected to the air supply/exhaust tube 34a. The pump 34 applies pressure, through the air supply/exhaust tube 34a and the reaction tank 30, to liquid held in the corresponding chamber of the cartridge 50. By appropriately setting the direction and speed of rotation of a stepping motor connected to the pump 34, it is possible to increase or decrease the pressure applied by the pump 34 to a component connected to the air supply/exhaust tube 34a. In the following description of the present embodiment, switching between an operation of supplying liquid from the reaction tank 30 to the cartridge 50 and an operation of supplying liquid from the cartridge 50 to the reaction tank 30 is made by actuating the pump 34 after the direction and speed of the stepping motor connected to the pump 34 are set. When it is necessary to adjust the pressure applied to a component connected to the air supply/exhaust tube 34a, the direction and speed of rotation of the stepping motor are set such that the pressure indicated by a pressure gage (not shown) in the air supply/exhaust tube 34a reaches a desired value.

The light detecting unit 60 includes the optical fiber 62 that transmits light incident from each of the DNA probes 53a, and a light detecting module 64 that converts light input through the optical fiber 62 into an electric signal. The optical fiber 62 is secured by the retainer 84 (see FIG. 9) of the cartridge holding mechanism 80. The optical fiber 62 has the collimating lens 62a attached to its one end. The collimating lens 62a serves as a light detector indicating a position at which light is detected. The optical fiber 62 is secured to the retainer 84 such that when the cartridge 50 is attached to the cartridge holding mechanism 80, the collimating lens 62a and the condenser lens 57 are opposite each other in the vertical direction. The light detecting module 64 is internally provided with a light detecting element (not shown) that detects light input through the optical fiber 62. The light detecting element outputs an electric signal corresponding to the intensity of received light.

The controller 40 is configured as a microprocessor centered on a CPU 42. The controller 40 includes a flash ROM 43 that stores various processing programs, and a RAM 44 that temporarily stores or saves data. The controller 40 outputs a control signal to the pump 34, a control signal to the motor 37, a control signal to the light detecting unit 60, and supply voltages to the Peltier device 36a for the reaction tank and the Peltier device 38a for the cartridge. The controller 40 inputs a detection signal from the light detecting unit 60.

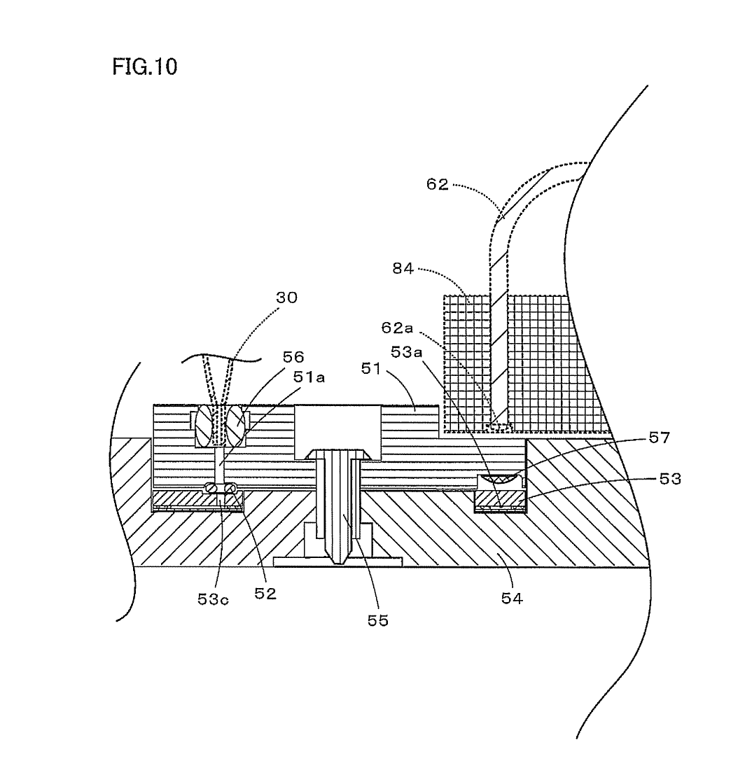

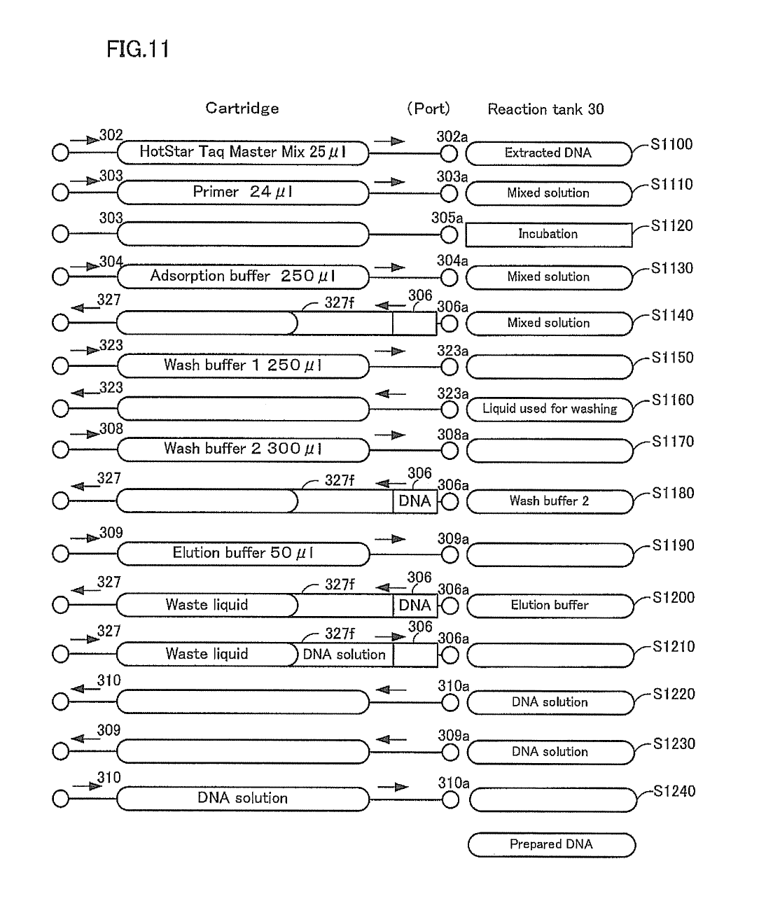

A cross section of the cartridge 50 attached to the cartridge holding mechanism 80 is illustrated in FIG. 10. FIG. 10 illustrates part of a cross section taken along line B-B′ of FIG. 2. FIG. 10 illustrates a state in which the cartridge body 54 is rotated relative to the circular valve 51 and positioned such that the through hole 51a of the circular valve 51 coincides with the channel inlet 53c of the ring array 53. As illustrated, the collimating lens 62a and the DNA probe 53a are opposite each other. The reaction tank 30 communicates with the channel inlet 53c through the through hole 51a of the circular valve 51.

In the analyzer 90 configured as described above, the cartridge 50 in which the ring array 53 is mounted on the cartridge body 54 in advance is used. In the cartridge 50, desired amounts of liquids including reagents used in predetermined reactions are separately stored in appropriate liquid containers. To sequentially supply liquids from the liquid containers 302 to 304, 308, 309, 311, 315 to 321, 323, and 325 to the reaction tank 30 for predetermined reactions in the reaction tank 30, and transport the liquids after the reactions to the waste liquid tanks 327 and 328, the motor 37 rotates the cartridge body 54 to allow the different ports of the cartridge body 54 to be sequentially connected to the reaction tank 30. In particular, purification of a reaction product is effected by adsorbing the reaction product to a column and discharging waste liquid to the waste liquid tank 327, eluting the reaction product adsorbed to the column with liquid held in any of the liquid containers, allowing the eluted reaction product to temporarily collect in the diffusion channel 327f, and supplying the eluted reaction product to the reaction tank 30. Since the reaction tank 30 of the analyzer 90 is provided outside the cartridge 50, changes in temperature in the reaction tank 30 are not easily transmitted to the cartridge 50. Therefore, temperatures in the reaction tank 30 and the cartridge 50 can be kept at different levels (e.g., a reaction temperature and a storage temperature). A motor (not shown) that rotates a magnet attached thereto is provided beside the reaction-tank securing unit 36, and a rotor including a magnet is provided inside the reaction tank 30. When the motor rotates the magnet attached thereto, the rotor rotates to stir liquid in the reaction tank 30.

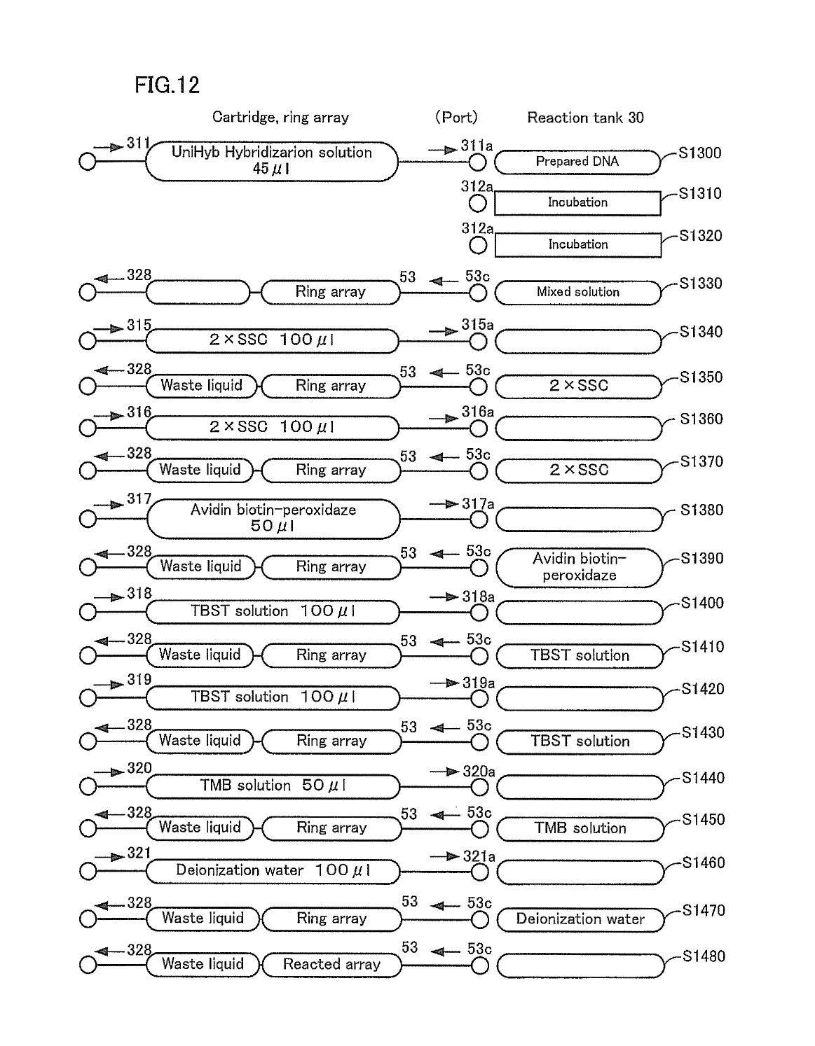

Next, an operation of the analyzer 90 will be described. In particular, a description will be given about a process in which rice genomic DNA, which is a sample, is amplified, prepared, and subjected to reaction with each of the DNA probes 53a formed in the ring array 53 and thus, light incident from each of the DNA probes 53a is detected. FIG. 11 is an explanatory diagram illustrating a process of amplifying and preparing genomic DNA of rice. FIG. 12 is an explanatory diagram illustrating a process of causing the prepared genomic DNA to react with the DNA probes 53a formed in the ring array 53. FIG. 11 and FIG. 12 schematically illustrate the liquid containers and the waste liquid tanks 327 and 328 of the cartridge 50, the injection port and distribution ports connected the chambers, and the reaction tank 30. In FIG. 11 and FIG. 12, the liquid containers 302 to 304, 308, 309, 311, 315 to 321, 323, and 325 and the waste liquid tanks 327 and 328 are illustrated with descriptions of the types and amounts of liquids held and the reference numerals shown in FIG. 5 to FIG. 8. In FIG. 11 and FIG. 12, chambers represented by blank spaces hold no liquid therein. The reaction tank 30 holding liquid therein is represented by a rounded rectangle, the reaction tank 30 holding liquid to be processed is represented by a rectangle, and the reaction tank 30 holding no liquid therein is represented by an empty rounded rectangle. Each arrow in the drawings indicates a direction in which liquid or gas flows. For convenience of explanation, step numbers are given to the representations of the reaction tank 30.

First, amplification and preparation of genomic DNA will be described with reference to FIG. 1, FIG. 9, and FIG. 11. The user first prepares the cartridge 50 in which liquids for identification of species of rice are stored. Next, the user places, in the reaction tank 30, genomic DNA of rice whose species is to be identified. The user then connects the reaction tank 30 to the circular valve 51 of the cartridge 50. Next, the user opens a door (not shown) on one side of the reaction-tank securing unit 36, connects the upper part of the reaction tank 30 to the air supply/exhaust tube 34a, and horizontally slides the cartridge 50 onto the rotating stage 38 such that the circular valve 51 is biased downward by the retainer 84. The retainer 84, which is made of Teflon, bends to allow the cartridge 50 to be placed on the rotating stage 38 such that the three raised portions 38b on the upper surface of the rotating stage 38 are fitted into the corresponding three grooves 342 (see FIG. 8) formed at the bottom of the cartridge body 54. Thus, the cartridge 50 is mounted on the rotating stage 38 while being biased downward by the retainer 84. At the same time, the contact portion 84a of the retainer 84 is fitted into contact with the notch 51d of the circular valve 51 of the cartridge 50, so that the collimating lens 62a and the condenser lens 57 are secured at positions where they face each other in the vertical direction. Then, the user presses the start button (not shown). In response, the CPU 42 of the controller 40 reads and executes a DNA preparation routine stored in the flash ROM 43. Upon running the DNA preparation routine, the CPU 42 drives the motor 37 to rotate the cartridge body 54 so as to allow the distribution port 302a to communicate with the reaction tank 30, actuates the pump 34 to reduce air pressure in the reaction tank 30, and allows liquid held in the liquid container 302 to be drawn into the reaction tank 30 (step S1100).

Next, the CPU 42 allows the distribution port 303a to communicate with the reaction tank 30, and actuates the pump 34 to allow liquid held in the liquid container 303 to be drawn out (step S1110). Next, the CPU 42 rotates the cartridge body 54 to allow the closed port 305a to be connected to the reaction tank 30, and performs stirring for 15 minutes to allow a reaction to occur in the reaction tank 30 while keeping the temperature therein at 95° C. Then, the CPU 42 performs 40 cycles, each involving stirring for 1 minute in the reaction tank 30 kept at a temperature of 95° C., stirring for 1 minute and 30 seconds at a temperature of 66° C., and stirring for 30 seconds at a temperature of 72° C. Last, the CPU 42 performs stirring for 10 minutes at a temperature of 72° C. to allow a reaction to occur (step S1120). The term “stirring” means to mix solutions in the reaction tank 30 by causing the motor 72 to rotate the rotor 47 placed in the reaction tank 30. Next, the CPU 42 allows the distribution port 304a to communicate with the reaction tank 30, and actuates the pump 34 to allow liquid (adsorption buffer (3.8 mol/L, ammonium sulfate)) held in the liquid container 304 to be drawn out (step S1130). Next, the CPU 42 allows the combined distribution port 306a to communicate with the reaction tank 30, and actuates the pump 34 to distribute the mixed solution in the reaction tank 30 to the column containing space 306 (step S1140). When the mixed solution flows, through the combined distribution port 306a (see FIG. 7) in the third layer 54c of the cartridge 50, into the column containing space 306, DNA contained in reaction mixture is adsorbed to the column in the column containing space 306. Then, waste liquid that has passed through the column further passes through the diffusion channel 327f (see FIG. 7) and is eventually discharged to the waste liquid tank 327.

Next, the CPU 42 allows the distribution port 323a to communicate with the reaction tank 30, actuates the pump 34 to allow liquid (first wash buffer (1.9 mol/L, ammonium sulfate)) held in the liquid container 323 to be drawn out, performs stirring for 1 minute while keeping the temperature in the reaction tank 30 at 25° C., and washes the inside of the reaction tank 30 (step S1150). The inside of the reaction tank 30 is washed to prevent salt precipitation. Next, the CPU 42 actuates the pump 34 to store, in the liquid container 323, the liquid used for washing the reaction tank 30 (step S1160). Next, the CPU 42 allows the distribution port 308a to communicate with the reaction tank 30, and actuates the pump 34 to allow liquid (second wash buffer (pH 6.0, 10 mmol/L, phosphoric acid-ethanol mixture (mixing ratio=1:2.8))) held in the liquid container 308 to be drawn out (step S1170). Next, the CPU 42 allows the combined distribution port 306a to communicate with the reaction tank 30, actuates the pump 34 to distribute the second wash buffer in the reaction tank 30 to the column containing space 306, and thereby washes the column (step S1180). Next, the CPU 42 allows the distribution port 309a to communicate with the reaction tank 30, actuates the pump 34 to allow liquid (elution buffer (pH 8.0, 20 mmol/L, tris-hydrogen chloride) held in the liquid container 309 to be drawn out (step S1190). Next, the CPU 42 allows the combined distribution port 306a to communicate with the reaction tank 30, actuates the pump 34 to distribute the elution buffer in the reaction tank 30 to the column containing space 306, and allows the eluate to collect in the diffusion channel 327f, not to flow out to the waste liquid tank 327 (step S1200). Specifically, after distributing the elution buffer to the column containing space 306, the CPU 42 causes the pump 34 (tube pump) to stop squeezing the tube. Since this allows amplified DNA adsorbed to the column to be eluted into the elution buffer, the solution containing the amplified DNA collects in the diffusion channel 327f.

After step S1200, the CPU 42 actuates the pump 34 to allow the elution buffer collecting in the diffusion channel 327f to be drawn back to the reaction tank 30 (step S1210). Next, the CPU 42 allows the injection port 310a to communicate with the reaction tank 30, and actuates the pump 34 to inject the elution buffer in the reaction tank 30 into the closed channel 310 (step S1220). Thus, air in the closed channel 310 is compressed by the injected liquid and increased in pressure. Next, the CPU 42 allows the distribution port 309a to communicate with the reaction tank 30, so as to allow the mixed solution remaining in the reaction tank 30 to be discharged to the liquid container 309 (step S1230). The pressure used in step S1220 to inject the mixed solution into the closed channel 310 remains in the reaction tank 30. Therefore, when the distribution port 309a communicates with the reaction tank 30, the remaining pressure causes the mixed solution in the reaction tank 30 to be discharged to the liquid container 309. Next, the CPU 42 allows the injection port 310a to communicate with the reaction tank 30, and supplies mixed solution injected into the closed channel 310 to the reaction tank 30 (step S1240). Prepared DNA is thus obtained. Since, in step S1240, the mixed solution is discharged to the liquid container 309 by the pressure remaining in the reaction tank 30, the pressure in the reaction tank 30 is reduced. However, the pressure of air in the closed channel 310 remains the same as that used for injection of the mixed solution in step S1220. Therefore, this difference in pressure causes the mixed solution injected into the closed channel 310 to be supplied to the reaction tank 30.

Next, with reference to FIG. 12, a description will be given about a process in which the prepared DNA is caused to react with the DNA probes 53a formed in the reaction channel 53b of the ring array 53. The CPU 42 of the controller 40 reads and executes a reaction processing routine stored in the flash ROM 43. This routine is executed following the completion of execution of the DNA preparation routine described above. Upon running the reaction processing routine, the CPU 42 allows the distribution port 311a to communicate with the reaction tank 30 holding the prepared DNA, and actuates the pump 34 to allow liquid held in the liquid container 311 to be drawn out (step S1300). Next, the CPU 42 rotates the cartridge body 54 to allow the closed port 312a to be connected to the reaction tank 30, and performs stirring for 5 minutes while keeping the temperature in the reaction tank 30 at 90° C. (step S1310). Next, the CPU 42 performs stirring for 5 minutes while keeping the temperature in the reaction tank 30 at 10° C. (step S1320). Next, the CPU 42 allows the channel inlet 53c to communicate with the reaction tank 30, and controls the actuation of the pump 34 to allow the mixed solution held in the reaction tank 30 to temporarily collect in the reaction channel 53b of the ring array 53. While causing the Peltier device 38a for the cartridge 50 to keep the temperature in the reaction channel 53b at 42° C. for 60 minutes, the CPU 42 allows a hybridization reaction to occur between the DNA probe 53a formed in the reaction channel 53b and target DNA in the mixed solution. Then, the CPU 42 actuates the pump 34 again to increase air pressure in the reaction tank 30, and allows the liquid temporarily collecting in the reaction channel 53b to be discharged to the waste liquid tank 328 (step S1330). Here, the mixed solution distributed to the ring array 53 is transported to the waste liquid tank 328 along the path described above.

Next, the CPU 42 allows the distribution port 315a to communicate with the reaction tank 30, and actuates the pump 34 to allow liquid held in the liquid container 315 to be drawn out (step S1340). Next, the CPU 42 allows the channel inlet 53c to communicate with the reaction tank 30, controls the actuation of the pump 34 to allow wash liquid held in the reaction tank 30 to temporarily collect in the reaction channel 53b of the ring array 53, and thus washes the reaction channel 53b while causing the Peltier device 38a to keep the temperature in the reaction channel 53b at 25° C. for 5 minutes. Then, the CPU 42 actuates the pump 34 again to increase air pressure in the reaction tank 30, and allows the wash liquid temporarily collecting in the reaction channel 53b to be discharged to the waste liquid tank 328 (step S1350). Next, the CPU 42 performs processing similar to that of step S1340 and step S1350 using liquid held in the liquid container 316 so as to wash the reaction channel 53b of the ring array 53 (step S1360 and step S1370). Next, the CPU 42 allows the distribution port 317a to communicate with the reaction tank 30, and actuates the pump 34 to allow liquid held in the liquid container 317 to be drawn out (step S1380). Next, the CPU 42 allows the channel inlet 53c to communicate with the reaction tank 30, controls the actuation of the pump 34 to allow liquid held in the reaction tank 30 to temporarily collect in the reaction channel 53b of the ring array 53, and causes a chemiluminescent reaction of the DNA probe 53a to occur while keeping the temperature in the reaction channel 53b at 25° C. for 30 minutes. Then, the CPU 42 actuates the pump 34 again to increase air pressure in the reaction tank 30, and allows the liquid temporarily collecting in the reaction channel 53b to be discharged to the waste liquid tank 328 (step S1390). Next, the CPU 42 performs processing similar to that of step S1340 and step S1350 using liquids held in the liquid containers 318 and 319 so as to wash the reaction channel 53b of the ring array 53 (step S1400 to step S1430). Next, the CPU 42 allows the distribution port 320a to communicate with the reaction tank 30, and actuates the pump 34 to allow liquid held in the liquid container 320 to be drawn out (step S1440). Next, the CPU 42 allows the channel inlet 53c to communicate with the reaction tank 30, controls the actuation of the pump 34 to allow liquid held in the reaction tank 30 to temporarily collect in the reaction channel 53b of the ring array 53, and causes a pigmentation reaction of the DNA probe 53a to occur while keeping the temperature in the reaction channel 53b at 25° C. for 30 minutes. Then, the CPU 42 actuates the pump 34 again to increase air pressure in the reaction tank 30, and allows the liquid temporarily collecting in the reaction channel 53b to be discharged to the waste liquid tank 328 (step S1450). Next, the CPU 42 allows the distribution port 321a to communicate with the reaction tank 30, and actuates the pump 34 to allow liquid held in the liquid container 321 to be drawn out (step S1460). Next, the CPU 42 allows the channel inlet 53c to communicate with the reaction tank 30, and distributes liquid held in the reaction tank 30 to the reaction channel 53b of the ring array 53 so as to stop the pigmentation reaction of the DNA probe 53a (step S1470). Thus, the pigmented DNA can be obtained in the ring array 53 (step S1480).

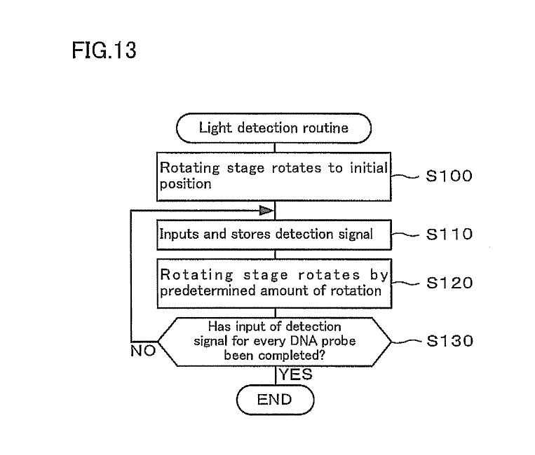

Next, a process of detecting light from the DNA probes 53a will be described. The CPU 42 of the controller 40 reads and executes a light detection routine stored in the flash ROM 43. FIG. 13 is a flowchart illustrating an example of the light detection routine. This routine is executed following the completion of execution of the reaction processing routine described above. Upon running the light detection routine, the CPU 42 controls the motor 37 such that the rotating stage 38 rotates to an initial position (step S100). The initial position is a position at which, of the plurality of DNA probes 53a, the first DNA probe 53a determined in advance faces the condenser lens 57 in the vertical direction. Next, the CPU 42 inputs a detection signal from the light detecting unit 60 and stores the received detection signal in the RAM 44 (step S110). Here, light incident from the DNA probe 53a located vertically opposite the condenser lens 57, which is above the ring array 53, is guided to the collimating lens 62a and detected. Next, the CPU 42 controls the motor 37 such that the rotating stage 38 rotates by a predetermined amount of rotation (step S120). The predetermined amount of rotation is an amount by which the rotating stage 38 rotates from a position which allows one DNA probe 53a to face the condenser lens 57, to another position which allows another DNA probe 53a spotted adjacent to the one DNA probe 53a to face the condenser lens 57. Next, the CPU 42 determines whether the input of a detection signal for every DNA probe 53a has been completed (step S130). This determination is made, for example, on the basis of whether the total amount by which the rotating stage 38 has rotated since the light detection routine was started has reached an angle by which the DNA probes 53a have been spotted, whether the rotating stage 38 has rotated once, or whether the number of detection signals stored in the RAM 44 has reached the number of DNA probes 53a spotted in advance. In this example, the determination is made on the basis of whether the total amount by which the rotating stage 38 has rotated from the initial position has reached an angle by which the DNA probes 53a have been spotted. If a negative determination is made in step S130, that is, if a detection signal for at least one of the DNA probes 53a has not been input, the processing of step S110 and the subsequent steps is performed. If a positive determination is made in step S130, that is, if the input of a detection signal for every DNA probe 53a has been completed, the present routine ends. Here, a plurality of detection signals stored in the RAM 44 represent a pigmentation pattern. Before execution of the present routine, pigmentation patterns of different species of rice are obtained and stored in the flash ROM 43. Then, a determination is made as to whether the pigmentation pattern obtained by execution of the present routine matches any of the pigmentation patterns stored in the flash ROM 43. Thus, it is possible to identify a particular species of rice. As described above, it is possible to execute the process from preparing target DNA to obtaining a pigmentation pattern without removing the cartridge 50 from the analyzer 90. Additionally, it is possible to visually identify a pigmentation pattern. In an array used for such visual identification of a pigmentation pattern, if DNA probes are spotted along a circumference, it is possible to identify a pigmentation pattern from its direction, in such a manner as to read the time (e.g., three o'clock, four o'clock, or five o'clock) from the direction of hands of an analog clock. For ease of identification, for example, the ring array 53 may be marked at zero o'clock, three o'clock, six o'clock, and nine o'clock positions.

The correspondence between the components of the present embodiment and the components of the present invention will now be described. The cartridge 50 of the present embodiment corresponds to a DNA-array-equipped cartridge of the present invention. The cartridge body 54 and the ring array 53 of the present embodiment correspond to a housing of the present invention. The liquid containers 302 to 304, 308, 309, 311, 315 to 321, 323, and 325 and the reaction channel 53b of the present embodiment correspond to fluid containing spaces of the present invention. The liquid containers 302 to 304, 308, 309, 311, 315 to 321, 323, and 325 of the present embodiment correspond to reagent containing spaces of the present invention. The reaction channel 53b of the present embodiment corresponds to a DNA array space of the present invention. The distribution ports 302a to 304a, 308a, 309a, 311a, 315a to 321a, 323a, and 325a and the channel inlet 53c of the present embodiment correspond to openings of the present invention. The circular valve 51 of the present embodiment corresponds to a circular valve of the present invention. The condenser lens 57 of the present embodiment corresponds to a light guide of the present invention. The cartridge holding mechanism 80 of the present embodiment corresponds to a holder of the present embodiment. The rotating stage 38 and the motor 37 of the present embodiment correspond to a rotator of the present invention. The collimating lens 62a of the present embodiment corresponds to a light detector of the present invention. The pump 34 of the present embodiment corresponds to a liquid transporter of the present invention.

In the cartridge 50 of the present embodiment described above in detail, when the cartridge body 54 is rotated such that the distribution ports 302a to 304a, 308a, 309a, 311a, 315a to 321a, 323a, and 325a of the liquid containers 302 to 304, 308, 309, 311, 315 to 321, 323, and 325 sequentially face the fluid port 30a of the reaction tank 30, the rotation of the cartridge body 54 is temporarily stopped in a state in which the reaction tank 30 faces each of the distribution ports 302a to 304a, 308a, 309a, 311a, 315a to 321a, 323a, and 325a, so that fluid is transported between the reaction tank 30 and each of the liquid containers 302 to 304, 308, 309, 311, 315 to 321, 323, and 325. Thus, target DNA can be prepared and eventually stored in the reaction tank 30. When the cartridge body 54 is rotated such that the channel inlet 53c faces the fluid port 30a of the reaction tank 30, it is possible to allow the target DNA in the reaction tank 30 to flow into the reaction channel 53b, and thus to allow the target DNA to react with each of the DNA probes 53a. Next, when the cartridge body 54 is rotated, light incident from each of the DNA probes 53a subjected to the reaction can be detected by the collimating lens 62a of the light detecting unit 60. Thus, it is possible to relatively easily carry out the process from preparation of the target DNA to detection of light incident from each of the DNA probes 53a at the collimating lens 62a.

The cartridge body 54 is easily rotatable since it has a disk-like shape. The cartridge body 54 is provided with the circular valve 51, and rotating the cartridge body 54 allows the distribution ports 302a to 304a, 308a, 309a, 311a, 315a to 321a, 323a, and 325a, the combined distribution port 306a, and the channel inlet 53c to sequentially face the through hole 51a of the circular valve 51. Thus, with a relatively simple structure, any one of the chambers and the reaction channel 53b can communicate with the reaction tank 30. Moreover, since the circular valve 51 has the condenser lens 57, the structure becomes simpler than the case where they are formed separately. Additionally, since the circular valve 51 has the condenser lens 57, light incident from each of the DNA probes 53a can be efficiently guided to the collimating lens 62a serving as a light detector.

As illustrated in FIG. 24, the channel outlet 53d of the ring array 53 extends downward from the connection port 328h, bends radially outward, extends upward, and then is connected to the waste liquid tank 328 through the horizontal waste liquid channel 328e. Thus, when the mixed solution temporarily collects in the reaction channel 53b of the ring array 53 in step S1330 to carry out the hybridization reaction for a predetermined period of time, the mixed solution in the reaction channel 53b can be prevented from gradually flowing into the waste liquid tank 328. That is, since the design is considered such that the liquid level of the mixed solution stops at a position in the middle of the vertical channels 328g and 328f, the mixed solution does not flow into the waste liquid channel 328e beyond the liquid surface. The mixed solution in the reaction channel 53b can be prevented from flowing into the waste liquid tank 328 as time passes.

It will be apparent that the present invention is not limited to the embodiments described above, and may be embodied in various forms within the technical scope of the present invention.

For example, in the ring array 53 of the embodiment described above, the plurality of DNA probes 53a are arranged in a row along a circumference. However, as long as it is possible to identify light incident from the DNA probes 53a in each row and to arrange the DNA probes 53a in the reaction channel 53b, the plurality of DNA probes 53a may be arranged in two or more rows along circumferences having different radii. This makes it possible to spot a larger number of DNA probes 53a. For example, the DNA probes 53a may be spotted in two rows along circumferences that are coaxial with the center axis 59 and have different diameters. To accommodate the DNA probes 53a spotted in two rows, two light detecting units 60, each corresponding to the DNA probes 53a in each row, may be provided. At the same time, the condenser lens 57 and the optical fiber 62 are provided at positions opposite relative to one of the DNA probes 53a in each row.

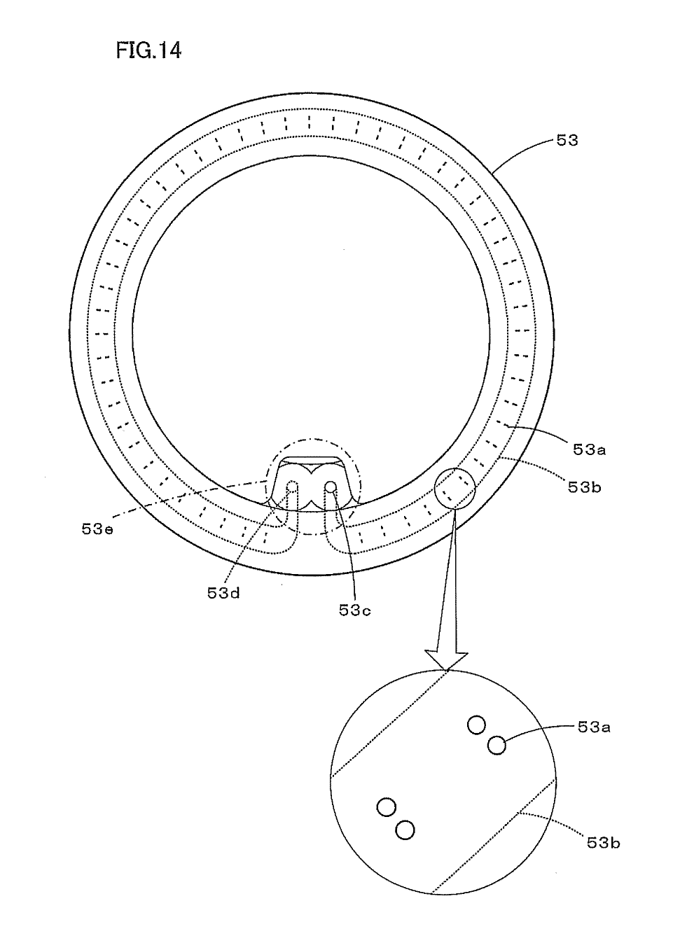

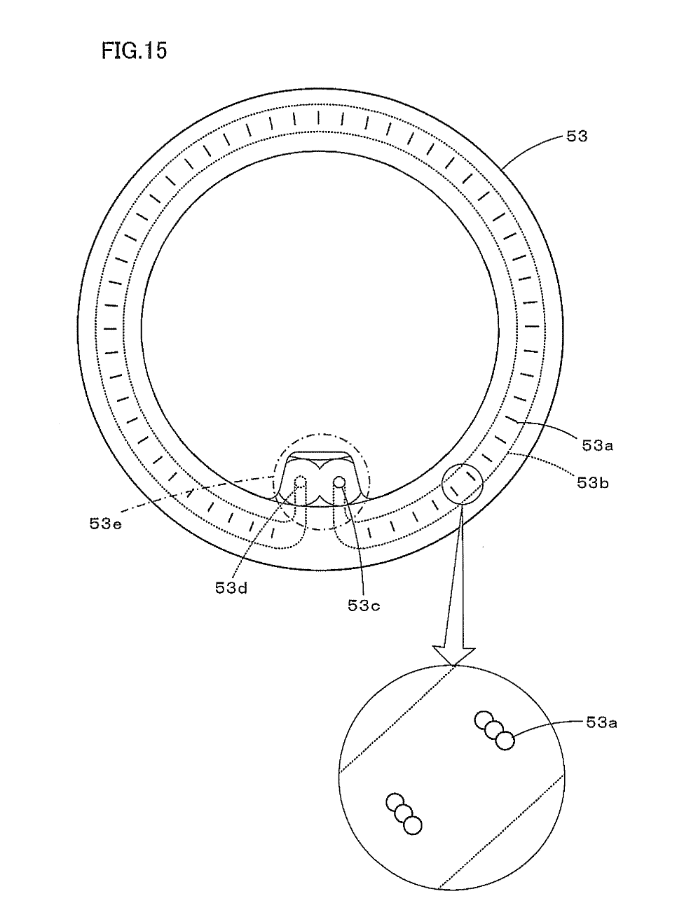

In the ring array 53 of the embodiment described above, the plurality of DNA probes 53a are arranged in a row along a circumference. However, a plurality of DNA probes may be spotted for each of the various DNA probes 53a arranged in a row. For example, two points each may be spotted, as illustrated in FIG. 14. In this case, the area where the light detecting unit 60 detects light may be an area that entirely covers the two spotted points. Thus, the intensity of detected light can be made greater than that in the case where only one point is spotted for each of the various DNA probes 53a. Alternatively, as illustrated in FIG. 15, three points may be spotted in an overlapping manner for each of the various DNA probes 53a. In this case, the area where the light detecting unit 60 detects light may either be an area that entirely covers the three spotted points or an area that partially covers the three spotted points. In the former case, the intensity of detected light can be made greater than that in the case where only one point is spotted for each of the various DNA probes 53a. In the latter case, if the area where the light detecting unit 60 detects light and the position of the spotted DNA probes 53a are displaced in the direction of radius of the circle along which the DNA probes 53a are arranged, it is possible to reduce the difference in intensity of detected light. In the examples described above, each DNA probe is formed in a dot (circular spot) shape in the reaction channel 53b by spraying microdroplets of solution containing DNA probes. When DNA probes are formed by printing, each DNA probe may have a shape other than a circular shape. For example, each DNA probe may have an elliptical shape or a rectangular shape, or may be formed as a string of circular spots.

The cartridge body 54 and the ring array 53 are provided as separate units in the embodiment described above, but they may be provided as a single unit.

The analyzer 90 includes the light detecting module 64 in the embodiment described above. Alternatively, the light detecting module 64 may be replaced with an external light detecting module, to which the optical fiber 62 is connected. In this case, the controller 40 transmits and receives control signals and detection signals to and from the external light detecting module.

In the embodiment described above, the analyzer 90 is configured such that, after a pigmentation reaction, light incident from each of the DNA probes 53a is detected through the optical fiber 62 by the light detecting module 64. Alternatively, the analyzer 90 may perform the following process. First, for preparing target DNA, the analyzer 90 fluorescently labels the target DNA and allows the prepared target DNA to be distributed to the reaction channel 53b. Thus, the fluorescently-labeled target DNA is located at a position of one of the plurality of DNA probes 53a, the one having been subjected to hybridization reaction with the target DNA. Next, light for producing fluorescence is applied to the DNA probes 53a. Fluorescence is produced at the position of the DNA probe 53a having been subjected to hybridization reaction with the target DNA, and is detected by the light detecting unit 60. This allows the user to recognize which of the DNA probes 53a has reacted with the target DNA, and thus to identify the target DNA. In this case, the analyzer 90 includes a light emitting unit that applies light for producing fluorescence to the DNA probes 53a. The light detecting module 64 may include the light emitting unit that applies, through the optical fiber 62, light for producing fluorescence to the DNA probes 53a. Specifically, for example, a filter may be provided between the light emitting unit and an end of the optical fiber 62 inside the light detecting module 64. The filter allows light for producing fluorescence, the light being to be incident on the optical fiber 62, to pass through such that the light output from the optical fiber 62 is divided into fluorescence and light for producing fluorescence. The light detecting element is provided at a position at which the resulting fluorescence is received.

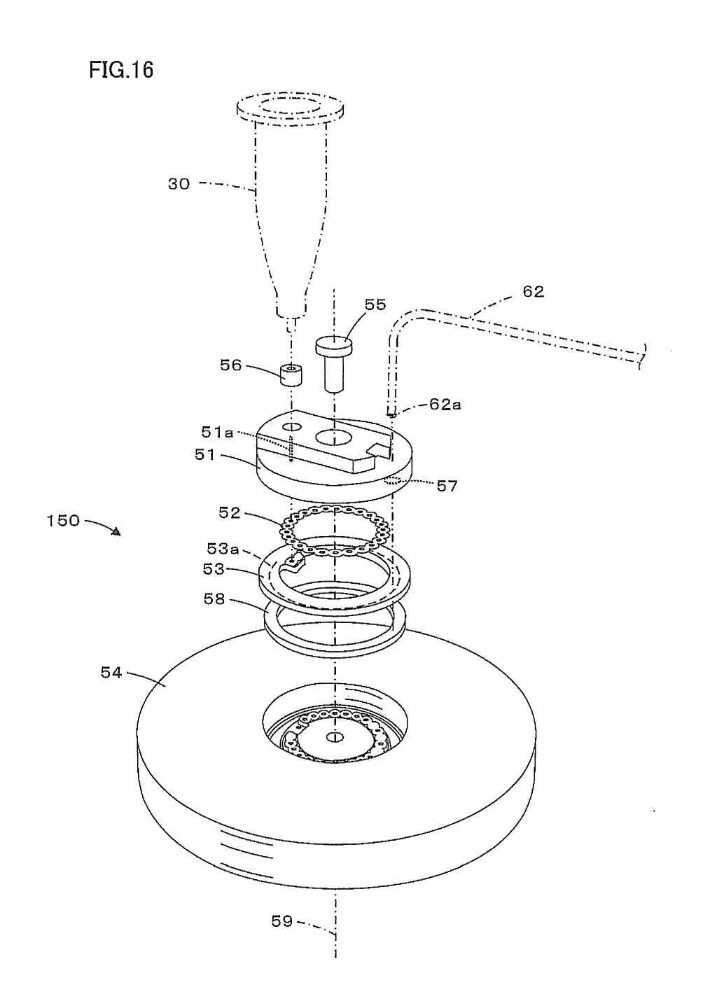

Although the cartridge 50 is used in the embodiment described above, a cartridge 150 including a highly thermal-conductive member 58 may be used. FIG. 16 is a perspective assembly diagram of the cartridge 150. The cartridge 150 includes the highly thermal-conductive member 58 disposed opposite the collimating lens 62a with respect to the ring array 53. That is, the highly thermal-conductive member is disposed under the ring array 53. The highly thermal-conductive member 58 is an annular member made of carbon-containing resin or metal. In the cartridge 150, the highly thermal-conductive member 58 having relatively high thermal conductivity is disposed under the ring array 53. Therefore, for a hybridization reaction between target DNA and the DNA probe 53a, it is possible to reduce variations in temperature among the spotted DNA probes 53a. Carbon-containing resin and metal have less fluorescence. Therefore, for examining target DNA using fluorescence, when light for producing fluorescence is applied to the DNA probe 53a opposite the collimating lens 62a, fluorescence other than the intended fluorescence can be prevented, to some extent, from being produced by the applied light. It is thus possible to reduce a fluorescent background detected by the collimating lens 62a. In addition, as illustrated in FIG. 17, a low-reflection ring 158 may be disposed on the same side as the collimating lens 62a of the optical fiber 62 with respect to the ring array 53, that is, the low-reflection ring 158 may be disposed above the ring array 53. The low-reflection ring 158 is made of a material similar to that of the highly thermal-conductive member 58. The low-reflection ring 158 has a through portion 158a at a position at which the through portion 158a faces the collimating lens 62a. Fluorescence from the DNA probes 53a of the ring array 53 can pass through the through portion 158a and be incident on the collimating lens 62a through the condenser lens 57. Thus, fluorescence other than the intended fluorescence can be further reliably prevented from being produced by the applied light.

Although the circular valve 51 has the condenser lens 57 in the embodiment described above, the circular valve 51 may be one without the condenser lens 57.

In the embodiment described above, the cartridge body 54 is composed of four layers, that is, the first layer 54a, the second layer 54b, the third layer 54c, and the fourth layer 54d. However, as long as chambers capable of holding liquid and discharging waste liquid are formed therein, the cartridge body 54 does not necessarily need to be composed of four layers. For example, the cartridge body 54 may be composed of three layers or five layers.

Although the cartridge body 54 of the above embodiment has a disk-like shape, the cartridge body 54 may have another shape, such as a rectangular shape or a hexagonal shape.

In the embodiment described above, the DNA preparation routine, the reaction processing routine, and the light detection routine are executed by the controller 40. Alternatively, an operation corresponding to these routines may be manually performed by the operator. In this case, there may be provided, for example, switches used by the operator to control the motor 37, the pump 34, the Peltier device 38a, the Peltier device 36a, and the light detecting unit 60, as well as a storage device for storing detected signals.

In the embodiment described above, the ring array 53 is used to identify a species of rice. However, the ring array 53 may be used for a different reaction. In this case, DNA probes for this different reaction may be formed in the reaction channel 53b. At the same time, the cartridge body 54 may hold liquids for use in this different reaction.

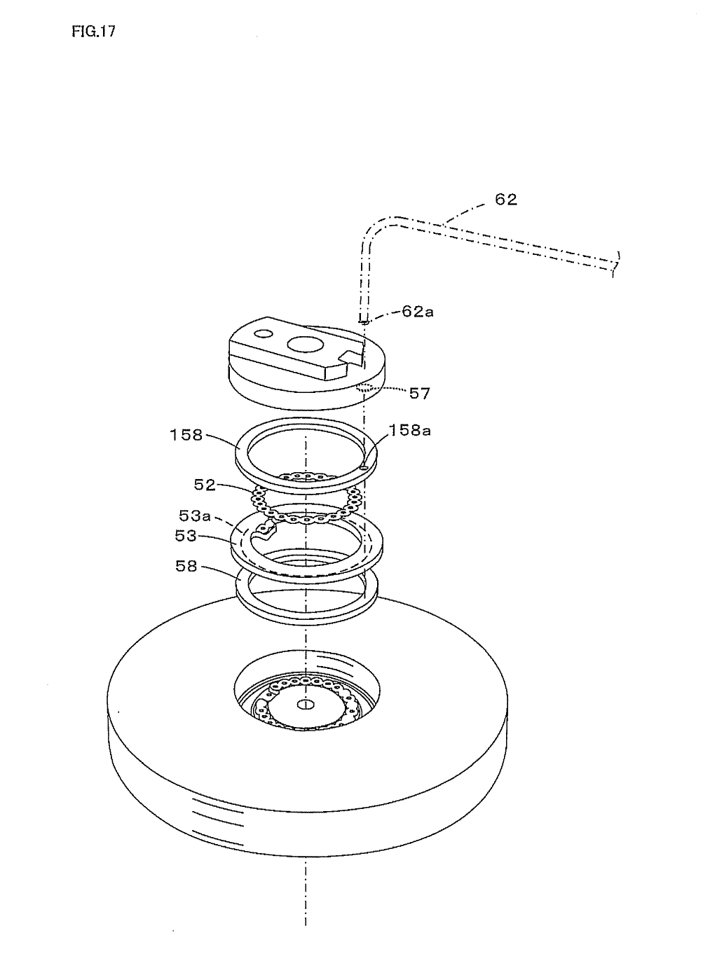

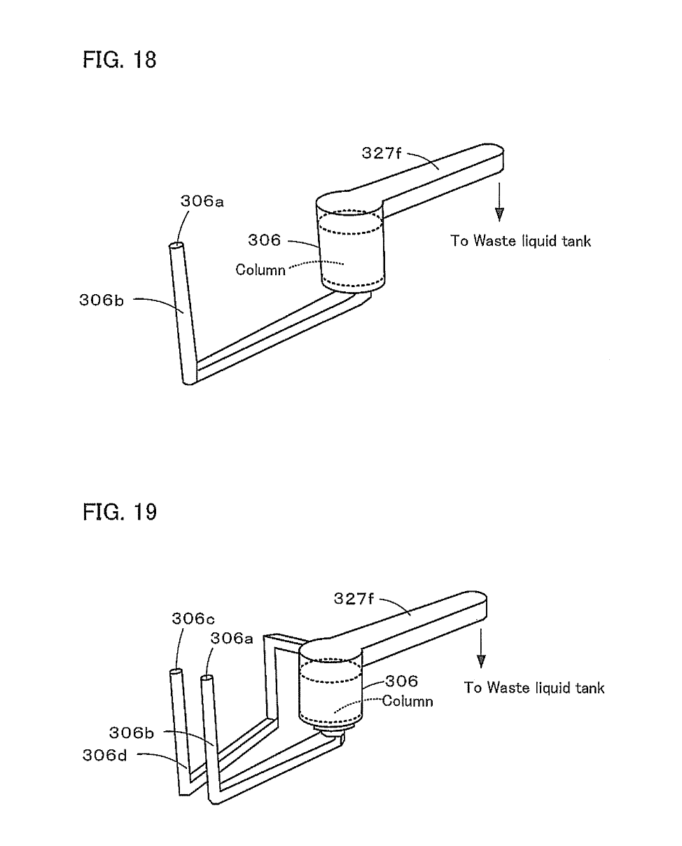

In the embodiment described above, though not described specifically, as illustrated in FIG. 18, the bottom of the column containing space 306 may be connected to a channel 306b extending downward from the combined distribution port 306a and then extending radially outward. Also, the upper surface of the column containing space 306 may be connected to the diffusion channel 327f connected to the waste liquid tank 327. In this case, when the mixed solution in the reaction tank 30 is distributed to the column containing space 306 in step S1140, the mixed solution flows from the combined distribution port 306a, passes through the column in the column containing space 306 from the lower side to the upper side, passes through the diffusion channel 327f, and then flows into the waste liquid tank 327. Thus, the target DNA is absorbed to the column. Subsequently, in step S1150, the inside of the reaction tank 30 is washed with the first wash buffer held in the liquid container 323. In step S1160, the liquid used for washing the reaction tank 30 is stored in the liquid container 323.

In steps S1170 and S1180, the second wash buffer held in the liquid container 308 flows from the combined distribution port 306a, passes through the channel 306b, passes through the column in the column containing space 306 from the lower side to the upper side in the reaction tank 30, passes through the diffusion channel 327f, and then flows into the waste liquid tank 327. Thus, the column is washed. In steps S1190 and S1200, the elution buffer held in the liquid container 309 flows from the combined distribution port 306a, passes through the channel 306b, passes through the column in the column containing space 306 from the lower side to the upper side in the reaction tank 30, and stops in the middle of the diffusion channel 327f (so as not to flow into the waste liquid tank 327). Thus, the DNA absorbed to the column is separated from the column and eluted into the elution buffer. In step S1210, the elution buffer (containing the DNA) in the diffusion channel 327f is drawn back to the reaction tank 30 through the combined distribution port 306a and the elution buffer is recovered.

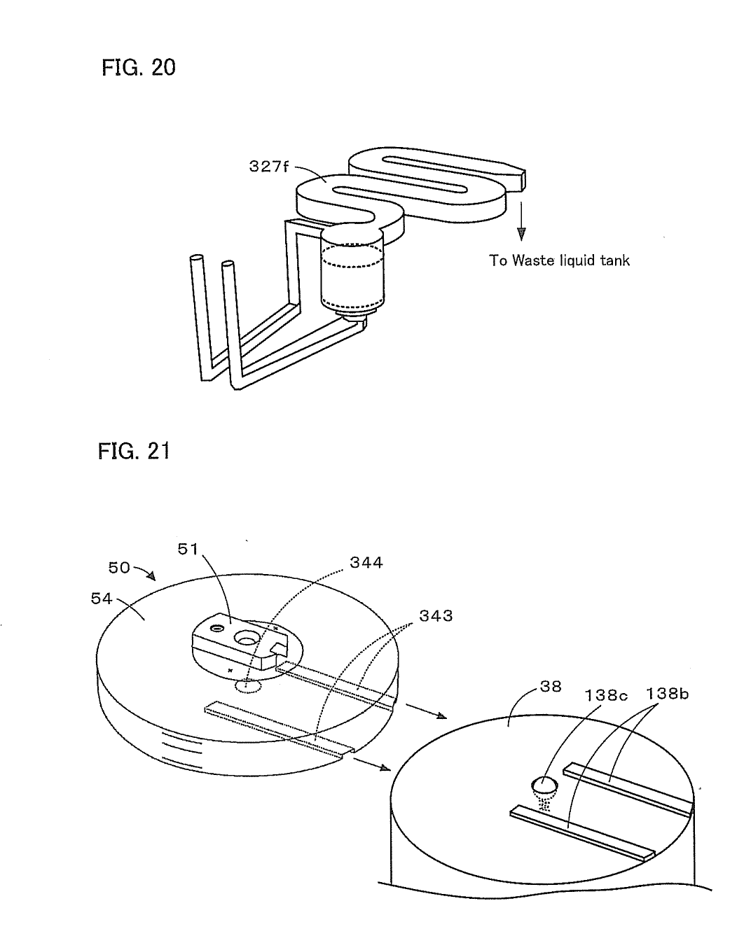

Alternatively, as illustrated in FIG. 19, a combined distribution port 306c may be disposed next to the combined distribution port 306a and arranged in parallel to the combined distribution port 306a. A channel 306d may extend downward from the combined distribution port 306c, extend radially outward, and then extend upward. The upper surface of the column containing space 306 may be connected to the channel 306d. Hereinafter, the combined distribution port 306a is referred to as a first combined distribution port 306a, and the combined distribution port 306c is referred to as a second combined distribution port 306c. In this case, the description of steps S1140 to S1160 will be omitted because these steps are similar to those in FIG. 18. After step S1160 and before step 51170, the diffusion channel 327f is washed. This point differs from the steps in FIG. 18. In particular, the wash liquid (for example, distilled water) in the channel is supplied from the second combined distribution port 306c with pressure. Then, the wash liquid in the channel passes through the channel 306d, passes through the upper part of the column in the column containing space 306, passes through the diffusion channel 327f, and then flows into the waste liquid tank 327. Since the opening of the first combined distribution port 306a is closed, the wash liquid in the channel does not pass through the column in the column containing space 306 from the upper side to the lower side. The diffusion channel 327f is a space where eluate collects in, which will be described later. Thus, washing the diffusion channel 327f can prevent the eluate from being contaminated. Then, in steps S1170 to S1200, the column is washed similarly to the steps in FIG. 18, and the DNA absorbed to the column is eluted into the elution buffer. Subsequently in step S1210, the elution buffer (containing the DNA) in the diffusion channel 327f is drawn back to the reaction tank 30. However, in this case, the first combined distribution port 306a is closed, so that the elution buffer is drawn out and recovered through the second combined distribution port 306c. The eluate can be recovered through the second combined distribution port 306c without passing through the column. Thus, recovery loss can be decreased as compared with the arrangement in FIG. 18, in which the eluate is recovered through the column. Here, the diffusion channel 327f may be formed in a zigzag fashion to increase the length of the diffusion channel 327f as illustrated in FIG. 20.

In the embodiment described above, the three grooves 342 (FIG. 8) are provided at the bottom of the cartridge body 54 and the three raised portions 38b (FIG. 9) are provided on the rotating stage 38. The raised portions 38b are fitted into the three grooves 342. Alternatively, the arrangement illustrated in FIG. 21 may be used. In particular, a plurality of linear grooves 343 may be provided at the bottom of the cartridge body 54 and linear rails 138b may be provided on the rotating stage 38. The linear rails 138b are fitted into the linear grooves 343. In this case, a ball pin 138c may be provided at the center of the rotating stage 38, and a hole 344 may be provided at the center of the bottom of the cartridge body 54. The ball pin 138c has a ball supported by a spring. The head of the ball pin 138c is fitted into the hole 344. To attach the cartridge 50 to the rotating stage 38, the cartridge 50 is slid such that the linear rails 138b are fitted into the linear grooves 343 while the upper surface of the rotating stage 38 is in contact with the bottom of the cartridge body 54. In the process of sliding, the bottom of the cartridge body 54 temporarily pushes down the ball pin 138c. When the cartridge 50 reaches a position at which the hole 344 of the cartridge body 54 corresponds to the ball pin 138c, the ball pin 138c being urged by the spring is fitted into the hole 344, so that the center axis of the cartridge 50 is aligned with that of the rotating stage 38. With this arrangement, the cartridge body 54 can be easily attached to the rotating stage 38 without the cartridge body 54 bending. Also, even with this arrangement, when the rotating stage 38 rotates, the cartridge 50 also rotates coaxially to the rotating stage 38.

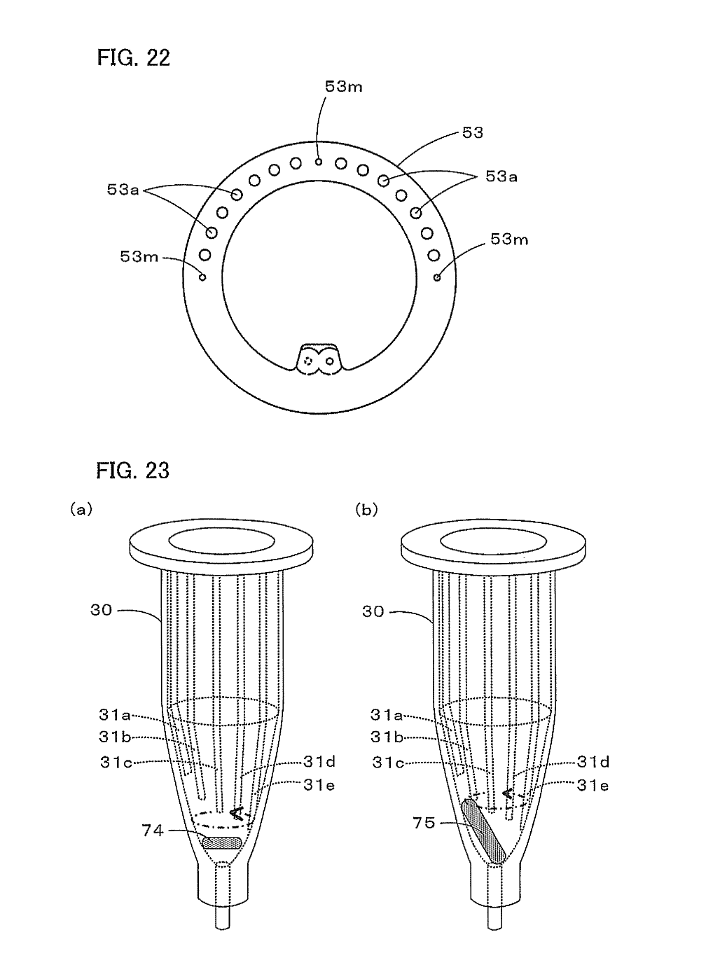

In the embodiment described above, the plurality of DNA probes 53a are spotted along the circumference of the ring array 53. Alternatively, as illustrated in FIG. 22, labeled markers 53m having labels with a high fluorescence intensity (for example, 5′-NH₂-TTTTTTTTTT-Cy3 or Cy5-3′) may be spotted at predetermined positions (for example, at nine o'clock, twelve o'clock, and three o'clock positions) of the ring array 53. The DNA probes 53a may be spotted at the other positions. With this arrangement, for example, when the bottom of the ring array 53 is not horizontal but is inclined, the fluorescence intensities of the labeled markers 53m may vary depending on the inclinations thereof. Hence, correction coefficients can be calculated respectively for the spotted positions of the DNA probes 53a on the basis of the variation amounts of the fluorescence intensities of the labeled markers 53m, and the fluorescence intensities of the DNA probes 53a can be corrected respectively with the correction coefficients. As a result, even when the bottom of the ring array 53 is not horizontal, the fluorescence intensities of the DNA probes 53a can be correctly obtained. Since the DNA probes 53a have lower fluorescence intensities than the labeled markers 53m, the spots of the DNA probes 53a preferably have larger size than the labeled markers 53m. For example, the spots of the labeled markers 53m may be small circles, whereas the spots of the DNA probes 53a may be ellipses or long circles. In FIG. 22, the DNA probes 53a are long circles arranged such that the longitudinal direction of the long circles is arranged in the vertical direction or the transverse direction. Alternatively, the longitudinal direction of the long circles may be arranged in the radial directions.

In the embodiment described above, though not described specifically, when the rotor including the magnet is provided in the reaction tank 30, the arrangement in which a long rotor 75 is used and the longitudinal direction of the rotor 75 is aligned with the vertical direction as illustrated in FIG. 23(b) is more preferable than the arrangement in which a short rotor 74 is used and the longitudinal direction of the rotor 74 is aligned with the transverse direction as illustrated in FIG. 23(a). The rotor 75 can stir the liquid in the reaction tank 30 more efficiently than the rotor 74 does although the amount of liquid is large.

In the embodiment described above, although the inner surface of the reaction tank 30 has not been particularly described, vertical grooves 31a to 31e for deaeration are preferably formed in the inner surface of the reaction tank 30 as illustrated in FIGS. 23(a) and 23(b). With the arrangement, the air can be efficiently removed from the liquid in the reaction tank 30. In particular, when the liquid held in any of the liquid containers in the cartridge body 54 is sucked into the reaction tank 30 by reducing the pressure of the liquid, the air may be drawn into the liquid. However, the air is drawn out to the upper side while being guided by the vertical grooves 31a to 31e. The vertical grooves 31a to 31e have different lengths (heights) from the fluid port 30a to the lower ends of the vertical grooves 31a to 31e. Thus, the liquid in the reaction tank 30 can be efficiently deaerated by any of the vertical grooves 31a to 31e irrespective of the amount of liquid.

If necessary, an antifoaming agent may be added to the liquid held in the liquid container of the embodiment described above. With the antifoaming agent, the liquid can be prevented from foaming when the liquid is transported from the liquid container to the reaction tank 30. In particular, when the liquid is highly viscous, the liquid may likely foam. Thus, the antifoaming agent is preferably added.

The present invention contains subject matter related to Japanese Patent Application No. 2008-313336 filed in the Japanese Patent Office on Dec. 9, 2008, and Japanese Patent Application No. 2009-218029 filed in the Japanese Patent Office on Sep. 18, 2009, the entire contents of which are incorporated herein by reference.

What is claimed is:

1. A DNA-array-equipped cartridge comprising:
a housing rotatable about a center axis;
a plurality of fluid containing spaces formed inside the housing and including a plurality of reagent containing spaces and a DNA array space, the reagent containing spaces holding fluids for preparation of target DNA, the DNA array space formed in a circumferential shape coaxial with the center axis and having a plurality of DNA probes spotted along the circumferential shape; and
a plurality of openings communicating with the corresponding fluid containing spaces, formed on an upper side of the housing, and arranged side-by-side along a circumference coaxial with the center axis,
wherein rotating the housing allows the plurality of openings to sequentially face a position setting a fluid port of a reaction tank independent of the housing, and allows the plurality of DNA probes to sequentially face a position setting a light detector independent of the housing.

2. The DNA-array-equipped cartridge according to claim 1, wherein the housing is formed in a substantially disk-like shape.

3. The DNA-array-equipped cartridge according to claim 1, wherein the plurality of DNA probes are spotted along a plurality of circumferential shapes coaxial with the center axis and having different diameters.

4. The DNA-array-equipped cartridge according to claim 1, further comprising a circular valve coaxial with the center axis of the housing, unrotatably secured, capable of supporting the reaction tank on an upper side of the circular valve, and having a through hole extending vertically therethrough from the fluid port of the reaction tank,
wherein rotating the housing allows the plurality of openings to sequentially face the through hole of the circular valve.

5. The DNA-array-equipped cartridge according to claim 1, further comprising a light guide configured to the position setting guide light to the light detector, the light being incident from the DNA probe facing the position setting the light detector.

6. The DNA-array-equipped cartridge according to claim 4, wherein the circular valve includes a light guide configured to guide light to the position setting the light detector, the light being incident from the DNA probe facing the position setting the light detector.

7. The DNA-array-equipped cartridge according to claim 5, wherein the light guide is a lens configured to collimate and guide light to a position setting the light detector, the light being incident from the DNA probe facing the light detector.

8. The DNA-array-equipped cartridge according to claim 6, wherein the light guide is a lens configured to collimate and guide light to a position setting the light detector, the light being incident from the DNA probe facing the light detector.

9. The DNA-array-equipped cartridge according to claim 1, further comprising a highly thermal-conductive member disposed opposite a position setting the light detector with respect to the DNA array space and made of carbon-containing resin or metal.

10. The DNA-array-equipped cartridge according to claim 8, further comprising a low-reflection ring disposed on the same side as a position setting the light detector with respect to the DNA array space, the low-reflection ring having a through portion communicating with the position setting the light detector and made of carbon-containing resin or metal.

11. The DNA-array-equipped cartridge according to claim 1,
wherein the plurality of fluid containing spaces include a column containing space and a waste liquid tank, the column containing space containing a column for purification of the target DNA, the waste liquid tank communicating with an upper part of the column containing space, and
wherein the plurality of openings include first and second openings communicating with the column containing space, the first opening communicating with a lower part of the column, the second opening communicating with an upper part of the column.

12. The DNA-array-equipped cartridge according to claim 1, wherein labeled markers are spotted at at least two predetermined positions in the DNA array space.

13. An analyzer comprising:
a holder for holding the DNA-array-equipped cartridge according to claim 1;
a rotator for rotating, about the center axis, the housing of the DNA-array-equipped cartridge held by the holder;
the reaction tank;
the light detector; and
a liquid transporter for transporting, through the corresponding openings, fluid held in the fluid containing spaces to the reaction tank, and fluid held in the reaction tank to the fluid containing spaces,
wherein when the housing of the DNA-array-equipped cartridge held by the holder is rotated by the rotator, the plurality of openings of the DNA-array-equipped cartridge sequentially face the fluid port of the reaction tank, and the plurality of DNA probes sequentially face the light detector.

14. A method for using the DNA-array-equipped cartridge according to claim 1, the method comprising the steps of:
(a) preparing the DNA-array-equipped cartridge in which fluids for preparation of the target DNA are held in the reagent containing spaces;
(b) preparing the reaction tank independent of the housing of the DNA-array-equipped cartridge and holding a sample from which the target DNA is prepared;
(c) rotating the housing to allow the openings of the reagent spaces to sequentially face the fluid port of the reaction tank, temporarily stopping the rotation of the housing in a state where the opening of each of the reagent spaces faces the reaction tank, transporting fluid between the reaction tank and the reagent space to prepare the target DNA, and eventually storing the target DNA in the reaction tank;
(d) rotating the housing to allow the opening of the DNA array space to face the fluid port of the reaction tank, causing the target DNA in the reaction tank to flow into the DNA array space, and causing the target DNA to react with each of the DNA probes; and
(e) rotating the housing and detecting light incident from each of the DNA probes subjected to the reaction by means of the light detector independent of the housing.
